(19) United States
(12) Patent Application Publication
(10) Pub. No.: US 2023/0271386 A1
(43) Pub. Date: Aug. 31, 2023

(54) METHOD OF FORMING A THREE-DIMENSIONAL (3D) PATTERN OR ARTICLE

(71) Applicants: DOW SILICONES CORPORATION, Midland, MI (US); DOW GLOBAL TECHNOLOGIES LLC, Midland, MI (US); THE REGENTS OF THE UNIVERSITY OF MICHICAN, Ann Arbor, MI (US)

(72) Inventors: Bizhong ZHU, Midland, MI (US); Stanley YEE, Midland, MI (US); Kurt A. KOPPI, Midland, MI (US); Jon V. DEGROOT, JR., Midland, MI (US); Albert SHIH, Ann Arbor, MI (US); Matthew HILDNER, Ann Arbor, MI (US); William VAN DEN BOGERT, Ann Arbor, MI (US); James LORENZ, Ann Arbor, MI (US)

(21) Appl. No.: 18/114,535

(22) Filed: Feb. 27, 2023

Related U.S. Application Data
(60) Provisional application No. 63/314,643, filed on Feb. 28, 2022.

(51) Int. Cl. B29C 64/393; B29C 64/343; B29C 64/209; B29C 64/118; B29C 64/264; B29C 64/336; B29C 64/314

(52) U.S. Cl. CPC B29C 64/393; B29C 64/343; B29C 64/209; B29C 64/118; B29C 64/264; B29C 64/336; B29C 64/314; B33Y 10/00

(57) ABSTRACT

A method of forming a three-dimensional (3D) pattern or article comprises: (1) selecting a first composition to be printed with a nozzle of an apparatus; (II) identifying desired characteristics of a pattern or layer (“pattern/layer”) to be formed by printing the first composition; (Ill) determining dimensional differences between the desired characteristics of the pattern/layer and predicted characteristics of the pattern/layer based on computational simulation modeling, or determining dimensional differences between the desired characteristics of the pattern/layer and actual characteristics of a trial layer, based on a flow rate of the first composition, a speed of a substrate and/or the nozzle, and the desired characteristics of the pattern/layer; and (IV) printing the first composition with the nozzle on the substrate to form the pattern/layer. The method comprises, during (IV) printing, (V) implementing a correction signal to adjust a flow rate of the first composition.

### CROSS-REFERENCE TO RELATED APPLICATIONS

This application claims priority to and all advantages of U.S. Prov. Appl. No. 63/314,643 filed on 28 Feb. 2022, the content of which is incorporated herein by reference.

### FIELD OF THE INVENTION

The present invention generally relates to a method of preparing a three-dimensional (3D) pattern or article and, more specifically, to a method of preparing a 3D pattern article which minimizes dimensional inconsistencies attributable to acceleration and deceleration during printing.

### DESCRIPTION OF THE RELATED ART

3D printing or additive manufacturing (AM) is a process of making three-dimensional (3D) solid objects, typically from a digital file. The creation of a 3D printed object is achieved using additive processes rather than subtractive processes. In an additive process, an object is created by laying down successive layers of material until the entire object is created. Each of these layers can be seen as a thinly sliced horizontal cross-section of the eventual 3D printed object.

Additive processes have been demonstrated with certain limited types of materials, such as organic thermoplastics (e.g. polylactic acid (PLA) or acrylonitrile butadiene styrene (ABS)), plaster, clay, room temperature vulcanization (RTV) materials, paper, or metal alloys. It's increasingly desirable to print complex geometries with softer materials, which exacerbate difficulties and defects associated with 3D printing. For example, when printing complex geometries, a nozzle of the 3D printer typically accelerates and decelerates when changing direction (e.g. around a 90-degree turn or a U-turn). Deceleration results in excess volume deposits at constant flow rates, and acceleration results in lesser volume deposits at constant flow rates, resulting in non-uniform or inconsistent dimensions in a printed layer or filament. Such defects and inconsistencies both limit opportunities for use of 3D printed materials due to aesthetics and necessary tolerances of certain end use applications.

### BRIEF SUMMARY

The present disclosure provides a method of forming on a substrate a three-dimensional (3D) pattern or article. The method comprises (I) selecting a first composition to be printed with the nozzle of the apparatus. The method further comprises (II) identifying desired characteristics of a pattern or layer to be formed by printing the first composition, wherein at least one of the substrate or the nozzle is moved relative to the other when printing the first composition to form the pattern or layer. In addition, the method comprises (Ill) determining dimensional differences between the desired characteristics of the pattern or layer and predicted characteristics of the pattern or layer based on computational simulation modeling, or determining dimensional differences between the desired characteristics of the pattern or layer and actual characteristics of a trial pattern or trial layer, based on a flow rate of the first composition, a speed of the substrate and/or the nozzle, and the desired characteristics of the pattern or layer. Further, the method comprises (IV) printing the first composition with the nozzle on the substrate to form the pattern or layer. The method comprises, during (IV) printing, (V) implementing a correction signal to adjust a flow rate of the first composition to minimize the dimensional differences between the desired characteristics of the pattern or layer and the actual or predicted characteristics of the pattern or layer. If desired, steps (I)-(V) may be optionally repeated with independently selected composition(s) to form any additional pattern(s) or layer(s). Finally, the method includes (VI) exposing the pattern(s) and/or layer(s) to a solidification condition. The step of (Ill) determining dimensional differences is not solely carried out in real time during the (IV) printing the first composition to form the pattern or layer. For example, the step of (Ill) determining dimensional differences is carried out at least partially ahead of the real time printing of the first layer by computational simulation modeling, machine learning from data accumulated from prior printing practices, or computational simulation enhanced by machine learning to increase prediction speed and/or accuracy. Step (V) includes generating the correction signal through computational iterations, or computational iteration/machine learning iterations to minimize or eliminate dimensional differences between desired characteristics of a pattern or layer and the actual characteristics of the pattern or layer.

The present disclosure also provides a 3D pattern or article formed in accordance with the method.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 shows details of an apparatus and nozzle including a positive displacement pump as utilized in one embodiment of the disclosure and its examples;

FIG. 2 shows details of an impeller spiral static mixer (ISSM) utilized in the positive displacement pump of FIG. 1;

FIG. 3 shows desired characteristics of a 90-degree turn of Example 1 and a U-turn of Example 2;

FIG. 4 shows further details of the desired characteristics of the 90-degree turn of FIG. 3;

FIG. 5 shows a 90-degree turn including a bulge as printed via conventional printing and microscopic images thereof;

FIG. 6 shows the flow rate of a first composition as printed to form the 90-degree turn via a conventional method and via the inventive method in Example 1;

FIG. 7 shows one example of an improvement comparing a 90-degree turn via a conventional method (including a bulge) and via the inventive method in Example 1;

FIG. 8 shows a U-turn including a bulge as printed via conventional printing and microscopic images thereof;

FIG. 9 shows additional details of the U-turn shown in FIG. 8;

FIG. 10 shows the flow rate of a first composition as printed to form the U-turn via a conventional method and via the inventive method in Example 2; and

FIG. 11 shows one example of an improvement comparing a U-turn via a conventional method (including a bulge) and via the inventive method in Example 2.

### DETAILED DESCRIPTION

The present disclosure provides a method of forming on a substrate a three-dimensional (3D) pattern or article. The 3D pattern or article is formed with independently selected compositions, which are described below, along with various aspects relating to the 3D pattern or article formed in accordance with the method disclosed herein. The 3D pattern or article may be customized for myriad end use applications and industries. For example, as described below, the 3D pattern or article may be soft and/or flexible and utilized in biological and/or health care applications. The inventive method may be utilized with different types of compositions to prepare different types of 3D patterns or articles with various properties, which can be customized based on desired end use application.

As described in greater detail below, the inventive method is a 3D printing process that minimizes dimensional inconsistencies or deviations attributable to acceleration and deceleration that necessarily arise in printing. These and other features will be understood in view of the description and examples herein.

The inventive method utilizes an apparatus having a nozzle. Various types of nozzles, apparatuses (e.g. 3D printers) and/or 3D printing methodologies (i.e., “3D printing processes”) can be utilized, as described in detail below.

The apparatus is suitable for use in “additive manufacturing” (AM) or “3D printing” processes (i.e., is a “3D printer”). Accordingly, this disclosure generally incorporates by reference in its entirety ASTM Designation F2792-12a, “Standard Terminology for Additive Manufacturing Technologies.” Under this ASTM standard, “3D printer” is defined as “a machine used for 3D printing” and “3D printing” is defined as “the fabrication of objects through the deposition of a material using a print head, nozzle, or another printer technology”. Likewise, “additive manufacturing” is defined as “a process of joining materials to make objects from 3D model data, usually layer upon layer, as opposed to subtractive manufacturing methodologies. Synonyms associated with and encompassed by 3D printing include additive fabrication, additive processes, additive techniques, additive layer manufacturing, layer manufacturing, and freeform fabrication”. AM may also be referred to as rapid prototyping (RP). As used herein, “3D printing” is generally interchangeable with “additive manufacturing” and vice versa.

In general, 3D printing encompasses myriad types of specific AM processes, which are typically referred to or classified based on a particular class of 3D printer utilized in the 3D printing process. Examples of these specific types of 3D printing processes include direct extrusion additive manufacturing, liquid additive manufacturing, fused filament fabrication, fused deposition modeling, direct ink deposition, material jetting, polyjetting, syringe extrusion, laser sintering, laser melting, stereolithography, powder bedding (binder jetting), electron beam melting, laminated object manufacturing, laser powder forming, ink-jetting, and the like. Such processes may be used independently or in combination in the method of this disclosure. 3D printers include extrusion additive manufacturing printers, liquid additive manufacturing printers, fused filament fabrication printers, fused deposition modeling printers, direct ink deposition printers, selective laser sintering printers, selective laser melting printers, stereolithography printers, powder bed (binder jet) printers, material jet printers, direct metal laser sintering printers, electron beam melting printers, laminated object manufacturing deposition printers, directed energy deposition printers, laser powder forming printers, polyjet printers, ink-jetting printers, material jetting printers, and syringe extrusion printers.

In certain embodiments, the apparatus comprises a 3D printer selected from a fused filament fabrication printer, a fused deposition modeling printer, a direct ink deposition printer, a liquid additive manufacturing printer, a material jet printer, a polyjet printer, a material jetting printer, and a syringe extrusion printer. In a specific embodiment, the apparatus comprises a 3D printer that is further defined as a direct ink deposition or write printer. In a further specific embodiment, the direct ink deposition or write printer is in fluid communication with a positive displacement pump. The positive displacement pump is utilized in lieu of a syringe to dispense the first composition, and helps to maintain a constant pressure (unlike a syringe). In certain embodiments, the positive displacement pump includes a static mixer through which the first composition flows. The static mixer, while part of the positive displacement pump, is particularly advantageous when the first composition comprises a two-part composition, which two-parts can be mixed homogenously via the static mixer prior to printing via dispensing through the nozzle.

Additionally, the 3D printer may be independently selected during each printing step associated with the disclosed method. Said differently, if desired, each printing step may utilize a different 3D printer or combinations of 3D printers. Different 3D printers may be utilized to impart different characteristics with respect to filaments and/or patterns and/or layers formed therewith, and different 3D printers may be particularly well suited for use with different types of compositions.

As the various types of 3D printing, and thus 3D printers, have substantial overlap with one another, e.g. based on a type of compositions and/or equipment utilized, 3D printers not specifically listed herein may also be utilized without departing from the scope of this disclosure. As such, the method of this disclosure can mimic (i.e., relate to) any one of the aforementioned 3D printing processes, or other 3D printing processes understood in the art.

As introduced above, regardless of its selection, the method utilizes the apparatus, e.g. the 3D printer, including the nozzle. However, other printing technology components, elements, or devices (e.g. physical and/or electronic) may be incorporated or used in conjunction with the apparatus and the nozzle. Examples of such components, elements, or devices include extruders, printing bases/platforms (e.g. stationary and/or motion controlled printing bases/platforms), various sensors/detectors (e.g. cameras, laser displacement sensors), computers and/or controllers, and the like, which may each be used independently or as part of a system (e.g. with the components in electronic communication with one another). Likewise, 3D printing is generally associated with a host of related technologies used to fabricate physical objects from computer generated data sources. Some of these specific processes are included above with reference to specific 3D printers. Further, some of these processes, and others, are described in greater detail below. Accordingly, many components and technologies may be utilized in connection with the method of this disclosure, as will be better understood in view of the general description of 3D printing process below.

In general, 3D printing processes have a common starting point, which is a computer generated data source or program which may describe an object. The computer generated data source or program can be based on an actual or virtual object. For example, an actual object can be scanned using a 3D scanner to give scan data, and the scan data can be used to make the computer generated data source or program. Alternatively, the computer generated data source or program may be designed from scratch, e.g. wholly or in combination with scan data.

The computer generated data source or program is typically converted into a standard tessellation language (STL) file format; however, other file formats can also or additionally be used. The file is generally read into 3D printing software, which takes the file and optionally user input to separate it into hundreds, thousands or even millions of “slices”. The 3D printing software typically outputs machine instructions, which may be in the form of G-code, which is read by the 3D printer to build each slice. The machine instructions are transferred to the 3D printer, which then builds the object layer-by-layer based on this slice information in the form of the machine instructions. Thicknesses of these slices may vary.

To affect the layer-by-layer printing, the nozzle and/or the build platform of the 3D printer generally moves in the X-Y (horizontal) plane before moving in the Z-axis (vertical) plane once each pattern or layer is complete. In this way, the object which becomes the 3D pattern or article is built one pattern or layer at a time from the bottom upwards. This process can use material for two different purposes, building the object and supporting overhangs in order to avoid extruding material into thin air. Alternatively, the nozzle moves in the vertical and horizontal planes simultaneously such that the patterns and/or layers are integrated and at least partially overlap in the Z-axis.

Optionally, the resulting objects may be subjected to different post-processing regimes, such as further heating, solidification, infiltration, bakeout, and/or firing. This may be done, for example, to expedite cure of any binder, to reinforce or form the 3D pattern or article from the object, to eliminate any curing/cured binder (e.g., by decomposition), to consolidate the core material (e.g., by sintering/melting), and/or to form a composite material blending the properties of powder and binder.

In various embodiments, the method of this disclosure mimics a conventional material extrusion process. Material extrusion generally works by extruding material (in this case, the first composition) through a nozzle to print one cross-section of an object, which may be repeated for each subsequent pattern or layer. The nozzle may be heated, cooled or otherwise manipulated during printing, which may aid in dispensing the particular composition.

The nozzle may comprise any dimension and be of any size and/or shape (e.g. conical or frusto-conical, pyramidal, rectangular, cylindrical, etc.). Typically, the dimensions of the nozzle are selected based on the particular apparatus, first composition, and any other compositions used to practice the method. One or more additional or supplemental nozzles may be used to practice the method in addition to the nozzle, with any of the one or more additional nozzles being selected based on any of the compositions being utilized, the particular pattern or layer being formed, the dimensions of the 3D pattern or article being formed, etc. For example, a plurality of nozzles may be utilized to print a particular composition (in series and/or simultaneously), or to print components to form a particular composition in situ.

In certain embodiments, the nozzle comprises a body extending between a base, which is proximal and connected to the apparatus, and a tip, and defines a cavity extending therethrough. The nozzle typically comprises an internal diameter (di) of from 0.001 to 100 mm, such as from 0.05 to 1, from 0.05 to 7, from 0.1 to 10, from 1 to 10, from 0.05 to 10, from 0.05 to 50, from 0.1 to 50, from 0.1 to 40, from 0.1 to 30, from 0.1 to 20, from 0.1 to 10, from 0.1 to 5, from 0.1 to 2, from 0.2 to 1, mm. The internal diameter (di) of the nozzle typically refers to the span of the cavity proximal the tip of the nozzle. However, the cavity may be any shape, such cylindrical, conical, rectangular, triangular, etc., and thus the nozzle may have multiple internal diameters, each measured at a different location along the body of the nozzle between the base and the tip. The internal diameter of the nozzle tip itself may be referred to with the designation “di”, as described herein.

The method comprises (I) selecting a first composition to be printed with the nozzle of the apparatus. The first composition is not limited and may be selected from any suitable composition based on the desired 3D pattern or article to be printed. The first composition may be curable or otherwise capable of solidification upon application of a solidification condition, as described below in regards to suitable compositions for use in the method. The first composition can be a thermoplastic, a thermoset, etc. The first composition is described in greater detail below.

The method further comprises (II) identifying desired characteristics of a pattern or layer to be formed by printing the first composition. At least one of the substrate or the nozzle is moved relative to the other when printing the first composition to form the pattern or layer.

By “desired characteristics,” it is meant the desired dimensional and pattern aspects, if any, of the pattern or layer to be formed by printing the first composition. For example, the pattern or layer may comprise a continuous or discontinuous layer, or may comprise a filament. By filament, it is meant that the pattern or layer may comprise or consist of a filament or strand, as opposed to a continuous layer, which filament or strand may be randomized, patterned, linear, non-linear, woven, non-woven, continuous, discontinuous, or may have any other form or combinations of forms. For example, the pattern or layer may be a mat, a web, or have other orientations. The pattern or layer may be patterned such that the pattern or layer comprises the filament in a nonintersecting manner. For example, the filament may comprise a plurality of linear and parallel filaments or strands. Alternatively, the filament may intersect itself such that the pattern or layer itself comprises a patterned or cross-hatched filament. The pattern or cross-hatching of the filament may present perpendicular angles, or acute/obtuse angles, or combinations thereof, at each intersecting point of the filament, which orientation may be independently selected at each intersecting point. Further still, the filament may contact and fuse or blend with itself such that portions of, alternatively the entirety of, the pattern or layer is in the form of a film. The desired characteristics include, in the case of the pattern or layer being a filament, a width, a thickness, and a height of the filament along its length, including at any intersecting points or non-linear portions (e.g. attributable to a turn, such as a 90-degree turn or U-turn). In the case of the pattern or layer being a film, the desired characteristics include the length and width of the film, as well as its thickness in any X or Y direction. The desired characteristics of the film can be any or all of the dimensional aspects of the pattern or layer. Typically, the desired characteristics are all dimensional aspects of the pattern or layer. Those desired characteristics may include sharp corners, sharp tips, edges involving printing one or multiple stop-and-then-go operations, and so on.

The substrate is not limited and, subject to the further description below, may be any substrate that can directly support the 3D pattern or article during its method of forming, or indirectly support the 3D pattern or article by itself being supported (e.g. by a table, such that the substrate itself need not have rigidity). The substrate may be discontinuous or continuous, e.g. in thickness, composition, rigidity, flexibility, etc. The composition of the substrate may vary, and may include various components and independently selected materials and/or compositions. General examples of suitable substrates include polymers such as silicones and other resins, metals, carbon fiber, fiberglass, and the like, as well as combinations thereof. The substrate may be any object, such as a printing base, built plate, mold, etc., and may include a coating or other film disposed thereon. The substrate may also be removable, e.g. peelable, from the 3D pattern or article printed thereon. Alternatively, the substrate may physically and/or chemically bond to the 3D pattern or article formed by the method.

The method also comprises (Ill) determining dimensional differences between the desired characteristics of the pattern or layer and predicted characteristics of the pattern or layer based on computational simulation modeling, or determining dimensional differences between the desired characteristics of the pattern or layer and actual characteristics of a trial pattern or trial layer, based on a flow rate of the first composition, a speed of the substrate and/or the nozzle, and the desired characteristics of the pattern or layer. Step (Ill) is carried out at least partially ahead of the real time printing of the first pattern or layer by computational simulation modeling, machine learning from data accumulated from prior printing practices plus real time printing data, or computational simulation enhanced by machine learning to increase prediction speed and/or accuracy.

For example, in certain embodiments, the speed of the substrate and/or the nozzle is dynamic due to the desired characteristics of the pattern or layer to be formed. In these embodiments, the dimensional differences between the desired characteristics of the pattern or layer and the actual or predicted characteristics of the pattern or layer are caused by changing the speed of the substrate and/or the nozzle. For example, when the desired characteristics of the pattern or layer include turns, e.g. a 90-degree turn or a U-turn, the nozzle and/or the substrate must decelerate in connection with entering the turn, and accelerate when completing the turn. When the flow rate of the first composition is constant, particularly via use of a positive displacement pump, deceleration of the nozzle and/or the substrate results in excess volume deposits of the first composition in the turn. Similarly, acceleration of the nozzle and/or the substrate results in lesser volume deposits of the first composition after the turn. As a result, use of a constant flow rate with a variable speed of the nozzle and/or the substrate results in inconsistent and undesirable deposition patters. This can be particularly problematic in end use applications where low tolerances and deviations in dimension are undesirable. Standard control algorithms adjust the flowrate to be linearly proportional to the nozzle speed, but frequently have limited successes. Experience has indicated that significant deviations from such standard control algorithms are needed to effect satisfactory printing. Typically, it's desirable for the pattern or layer to have substantially constant dimensions. In the case of the pattern or layer comprising the filament, it's desirable for the filament to have a constant width and height along its length, including in any turns or intersecting points of the filament. The inventive solves this undesirable defect associated with conventional printing, resulting in substantially consistent dimensions, especially as compared to the desired characteristics of the pattern or layer.

In certain embodiments, (Ill) determining dimensional differences between the desired characteristics of the pattern or layer and the actual or predicted characteristics of the pattern or layer is based on predicted characteristics of the pattern or layer from computational simulation.

For example, based on a Reynolds transport theorem analysis of fluid flow inside a pipe, a series of generalized equations, the continuity and momentum equations, are derived. The continuity and momentum equations are the basic equations of fluid dynamics. The most common forms of the one-dimensional continuity equation, Equation (1), and the momentum equation, Equation (2), are:

$$\frac{δ P}{δ t} + \frac{Q}{A} \frac{δ P}{δ x} + \frac{ρ {a}^{2}}{A} \frac{δ Q}{δ x} = 0 \qquad ( 1 )$$

$$\frac{1}{A} \frac{δ Q}{δ t} + \frac{Q}{{A}^{2}} \frac{δ Q}{δ x} + \frac{1}{ρ} \frac{δ P}{δ x} + g sin θ + F = 0 \qquad ( 2 )$$

where P is pressure, t is time, Q is the volumetric flowrate in the pipe, A is the pipes cross-sectional area, ρ is the fluid density, a is acoustic wave speed, x is the location along the central axis, g is gravity, θ is the angle of gravity relative to the central axis, and F is the frictional model for the system. The effect of transient flow is unidirectional, and only the one-dimensional forms of the continuity and momentum equation are needed. This analysis accounts for compression of the fluid through the inclusion of a which is important for describing the transient behavior. In an one-dimensional system, the convective acceleration terms, q/A δP/δx and Q/A² δQ/δx, and the gravitational term, g sin θ, can be ignored because they tend to be small in comparison to the other terms of the continuity and momentum equations. Using this simplification, the continuity and momentum equations, as shown in Equations (3) and (4), are:

$$\frac{δ P}{δ t} + \frac{ρ {a}^{2}}{A} \frac{δ Q}{δ x} = 0 \qquad ( 3 )$$

$$\frac{1}{A} \frac{δ Q}{δ t} + \frac{1}{ρ} \frac{δ P}{δ x} + F = 0 \qquad ( 4 )$$

The friction model, F, for the fluid system plays a significant factor in determining fluid behavior in the continuity and momentum equations. A common friction model is the quasi steady-state friction model based on the Darcy-Weisbach Equation, Equation (5), that treats each finite length of fluid flow as steady-state and uses the local volumetric flowrate to calculate F:

$$F = \frac{fQ \vert Q \vert}{2 {DA}^{2}} \qquad ( 5 )$$

where f is the Darcy friction factor. For DIW systems with pipe and laminar flow, f is found as:

$$f = \frac{64 μ A}{ρ QD} \qquad ( 6 )$$

where μ is the fluid viscosity.

Empirical models for static mixers have established that pressure drop within a unit length of static mixer, ΔPₘᵢₓₑᵣ, is proportional to the pressure drop within a unit length of a pipe, ΔPₚᵢₚₑ, for a given flow and expressed using the parameter Kₗ:

$${K}_{l} = \frac{Δ {P}_{mixer}}{Δ {P}_{pipe}} \qquad ( 7 )$$

Kₗ can be included in a modified Darcy friction factor f_{mod}.

f_{mod}=Kₗf (8)

In specific embodiments, the status mixer is utilized in the apparatus, and has a Kₗ of 5.5. For transient flows that are transferring between steady states without oscillations, a quasi-steady-state friction model will accurately predict the flow behavior because the dampening effect of local and convective acceleration have an insignificant impact on flow behavior. With the quasi-steady-state assumption for transient flow behavior, it is possible to expand the continuity and momentum equations to include static mixers using Equation (8), since the steady-state flow behavior is similar to the pipe flow.

This quasi-steady-state assumption for Fallows for the inclusion of more complex forms of fluid flow, such as non-Newtonian flow and tapered pipe flow. For non-Newtonian fluids viscosity, μ_{eff}, is modeled using the power law.

μ_{eff}=kG′ⁿ⁻¹ (9)

where k is the fluid constancy index, n is the flow behavior index, and G′ is the shear rate experienced by the non-Newtonian fluid, and G′ is given by Equation (10):

G′=K_{G}Q/DA (10)

where K_{G} is the pipe shear constant.

Substituting Equations (6)-(9) into Equation (5) gives a single equation for F includes the effects of a static mixer and a non-Newtonian fluid.

$$F = \frac{128 {K}_{l} {k ( {K}_{G} Q / DA )}^{n - 1} \vert Q \vert}{ρπ {D}^{4}} \qquad ( 11 )$$

For tapered nozzles, K₁ is derived in the same manner as it is for static mixers. The steady-state ΔPₚᵢₚₑ as shown in Equation (5) can be used to derive the pressure drop in a tapered nozzle ΔPₜₐₚₑᵣ. A tapered nozzles diameter Dₜₐₚₑᵣ varies linearly along its length, L, according to Equation (12).

$${D}_{taper} = {D}_{in} + ( {D}_{out} - {D}_{in} ) \frac{x}{L} \qquad ( 12 )$$

where x is the positional location along the tapered nozzle length, Dᵢₙ is the inlet diameter, and Dₒᵤₜ is the outlet diameter.

Taking the derivative of both Equations (5) and (12) results in Equations (13) and (14).

$$\frac{{dD}_{taper}}{dx} = \frac{( {D}_{out} - {D}_{in} )}{L} \qquad ( 13 )$$

$$\frac{dP}{dx} = \frac{128 μ Q}{π {{D}_{taper} ( x )}^{4}} \qquad ( 14 )$$

Substituting Equation (13) into Equation (14) to eliminate dx,

$$dP = \frac{- 128 μ LQ}{π ( {D}_{out} - {D}_{in} )} \frac{dD}{{{D}_{taper} ( x )}^{4}} \qquad ( 15 )$$

and then integrating both sides along the length of the tapered nozzle

$$Δ {P}_{taper} = \frac{- 128 μ LQ}{π ( {D}_{out} - {D}_{in} )} ( \frac{1}{3 {D}_{in}^{3}} - \frac{1}{3 {D}_{out}^{3}} ) \qquad ( 16 )$$

which using Equation (7) gives

$${K}_{L} = \frac{- {D}_{in}}{( {D}_{out} - {D}_{in} )} ( \frac{1}{3 {D}_{in}^{3}} - \frac{1}{3 {D}_{out}^{3}} ) \qquad ( 17 )$$

Repeating the steps shown in Equations (12)-(17) but also using the power-law Equation, Equation (9), gives the following:

$$Δ {P}_{taper} = \frac{128 kLQ}{3 n ( {D}_{out} - {D}_{in} )} ( {( 3 π {D}_{out}^{3} )}^{- n} - {( 3 π {D}_{out}^{3} )}^{- n} ) {( {K}_{g} Q )}^{n - 1} \qquad ( 18 )$$

$${K}_{L} = \frac{- {D}_{in} ( {D}_{in}^{3 n} - {D}_{out}^{3 n} )}{3 n ( {D}_{in} - {D}_{out} ) {D}_{out}^{3 n}} \qquad ( 19 )$$

There are several numerical methods available to solve Equations (3) and (4). In Specific embodiments, the characteristic method (CM) is utilized. CM turns Equations (3) and (4) into ordinary differential equations using a linear combination of Equations (3) and (4) and the total derivatives of Q and p, resulting in Equations (20) and (21).

$$\frac{dQ}{dt} \pm \frac{A}{a ρ} \frac{dP}{dt} + AF = 0 \qquad ( 20 )$$

$$\frac{dx}{dt} = \pm a \qquad ( 21 )$$

Equations (20) and (21) are the mathematical representation of the disturbance at a point traversing in a fluid through both time, t, and space, x, along characteristic lines created by Equation (21). For every step in time, tᵢ, in the CM, an interior point, A, is connected by two characteristic lines to two adjacent points, B and C, from the preceding time step, tᵢ₋₁. The numerical solution to Equations (20) and (21) are shown in Equations (22) and (23), which use the P at points B and C in the previous time step to find Q and P at point A.

$${Q}_{i , j} = {Q}_{i - 1 , j - 1} + \frac{{AP}_{i - 1 , j - 1}}{a ρ} - {F}_{i - 1 , j - 1} Δ t + \frac{{AP}_{i , j}}{a ρ} \qquad ( 22 )$$

$${Q}_{i , j} = {Q}_{i + 1 , j - 1} - \frac{{AP}_{i + 1 , j - 1}}{a ρ} - {F}_{i + 1 , j - 1} Δ t + \frac{{AP}_{i , j}}{a ρ} \qquad ( 23 )$$

The ratio of the time steps, Δt, and the length steps, Δx, is the same as the a

$$\pm a = \frac{Δ x}{Δ t} \qquad ( 24 )$$

Combining this iterative procedure with boundary conditions to solve for the exterior points creates a characteristic grid of fluid pressure and speed at every length step and time step.

In specific embodiments utilizing the CM for computational modeling, the boundary conditions are constant pressure outlet and a volumetrically controlled inlet. The constant pressure outlet boundary condition assumes that the pressure of the outlet, P_{i,outlet}, is held constant at gauge pressure. Using P_{i,outlet}, P_{i-1,n-1}, and Q_{i-1,k-1} and based on Equation (22), the volumetric outlet flow, Q_{i,outlet}, can be found:

$${Q}_{i , outlet} = {Q}_{i - 1 , k - 1} + \frac{{AP}_{i - 1 , k - 1}}{a ρ} - AF Δ t - \frac{{AP}_{outlet}}{a ρ} \qquad ( 25 )$$

where k is the total number of length steps used in the CM.

The volumetric flow controlled inlet boundary condition assumes that the flowrate of the inlet, Q_{i,inlet}, can be varied according to an arbitrary time function.

Q_{i,inlet}=Q(t) (26)

Using Q_{i,inlet}, P_{i-1,2}, and Q_{i-1,2} the inlet pressure, P_{i,inlet} can be found using Equation (27).

$${P}_{i , inlet} = a ρ A ( {Q}_{i , inlet} - {Q}_{i - 1 , 2} + \frac{{P}_{i - 1 , 2}}{a ρ} + F Δ t ) \qquad ( 27 )$$

Open-source one-dimensional water hammer code can be adopted to simulate the transient flow in DIW systems. The code uses CM to solve the transient fluid problem and can be modified to allow for the boundary conditions needed to simulate the DIW. The modification includes new frictional terms for an impeller spiral static mixer (ISSM) and tapered nozzle and to allow for vectorization of the solver to improve its computational efficiency. CM is evaluated by modeling the step response of a DIW system in a two-step response test. The two-step response test will validate the CM's ability to predict DIW characteristics using pressure and volumetric output data measured during testing. Experimentally, a specific DIW tool path with a 90-degree turn can be used to measure the shape of the deposited material and demonstrate the CM's ability to predict DIW behavior.

For example, a 90-degree turn is a simple tool path feature that requires the system to experience acceleration and deceleration during its deposition. The print profile and corner swell of the 90-degree corner can be compared between the CM and experimental printing results.

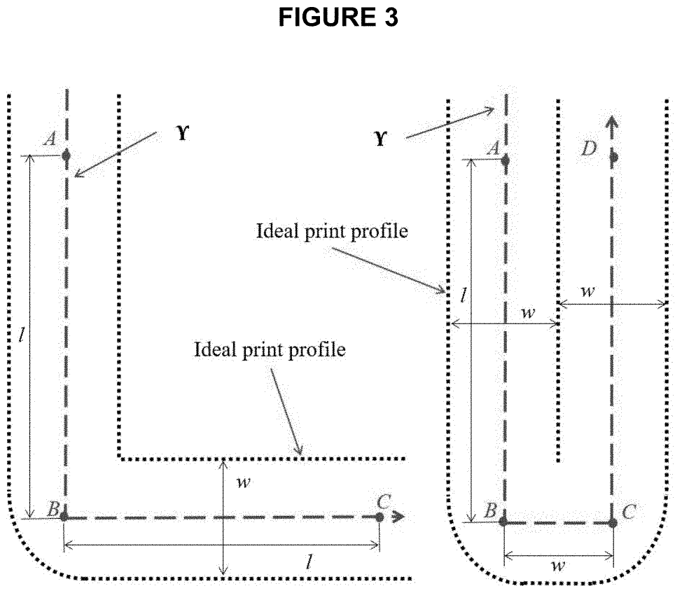

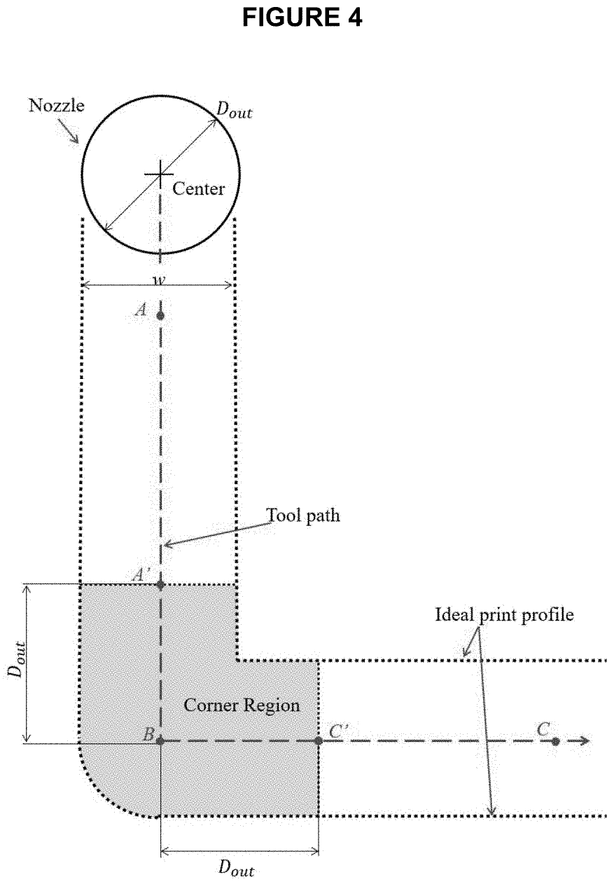

The tool path for the 90-degree corner, followed by the center of the DIW nozzle, is shown in FIG. 3. The ideal 90-degree corner will have a profile that is w wide along the entirety of the tool path. Point A is the beginning of the nozzle deceleration, point B is the point of minimum nozzle velocity and starting of acceleration, and point C is the end of the nozzle acceleration. At point B, there may be excess fluid deposited which causes corner swell. The corner region, as defined by a distance equal to Dₒᵤₜ from point B is shown in FIG. 4 is denoted by the points A′ and C′.

For the tool path outside of the corner region, the print nozzle is moving with a constant speed such that the shape can be approximated as a rectangular prism where the width, w, is determined by the flowrate Q_{i,outlet} (see Equation (25)), the nozzle velocity, vᵢ, and pattern or layer height, h_{layer}.

$$w = \frac{{Q}_{i , outlet}}{{w}_{i} {h}_{layer}} , ∀ i < {i}_{{A}^{′}} \vert \vert i > {i}_{C ′} \qquad ( 28 )$$

To predict the size of the swelling at point B, it is assumed that the total material deposited during the path of the nozzle between points A′ and C′ is extruded outward in a cylindrical shape with a pattern or layer height of h_{layer}. The diameter of the swelling at point B, D_{swell}, is

$${D}_{swell} = \sqrt{\frac{4 \sum {Q}_{i , outlet} Δ t}{π {h}_{layer}}} , ∀ {i}_{{A}^{′}} \leq i \leq {i}_{C ′} \qquad ( 29 )$$

To simulate the transient fluid flow using CM, the following parameters are needed, k, n, ρ, a, L, D, K_{g}, K_{L}, ΔX, and Δt. Parameters k, n, ρ, and a are known in the art and a function of the first composition selected for use in the method.

In certain embodiments, the predicted characteristics of the pattern or layer, whether via CM or otherwise, can be validated. For example, in one embodiment, a trial pattern or trial layer can be printed and analyzed to compare actual characteristics for comparison to desired characteristics of the pattern or layer. The trial pattern or trial layer can be analyzed via various techniques, e.g. via a digital microscope camera, optionally calibrated with a caliper digital caliper.

The image from the microscope camera can be processed, for example in Matlab™ (R2019B) to measure the print profile, tool path, and corner swell of the pattern or layer. The print profile typically consists of two lines, the outer print profile, [symbol] , and the inner print profile, [symbol] . Boundary lines can be smoothed, e.g. with a 61st order Savitzky-Golay filter (sgolayfilt) using a frame length of 10 mm to define [symbol] and [symbol] .

Using the k, n, p, a, L, D, K_{g}, K_{L}, ΔX, and Δt parameters and volumetric inputs described above, the CM can model of a two-step response for the apparatus.

In these or other embodiments, (Ill) determining dimensional differences between the desired characteristics of the pattern or layer and the actual or predicted characteristics of the pattern or layer is carried out by first printing a trial pattern or trial layer of the first composition. For example, rather than (or in addition to) computational simulation modeling, a trial pattern or trial layer can be printed based on a desired apparatus, a first composition, and desired characteristics of the pattern or layer. Dimensional differences between the desired characteristics of the pattern or layer and the actual characteristics of the trial pattern or trial layer can then be measured. Any suitable technique for measuring actual characteristics of the trial pattern or trial layer can be utilized. For example, in one embodiment, determining dimensional differences between the desired characteristics of the pattern or layer and the actual characteristics of the trial pattern or trial layer comprises microscopic imaging of actual characteristics of the trial pattern or trial layer as compared to the desired characteristics of the pattern or layer. Actual printing practices using similar or the same materials can accumulate difference data and these can be used in lieu of printing a trial pattern or trial layer. Further, accumulated data, alone or together with real time generated printing data, can be fed into a machine learning algorithm to predict the differences when an object of different shape is to be printed, a similar shape is to be printed at a different speed. Further, machine learning with those data can be used to enhance the speed and/or accuracy of computational simulation prediction of differences.

The method comprises (IV) printing the first composition with the nozzle on the substrate to form the pattern or layer.

As described above, at least one of the substrate and the nozzle is moved in the X-Y (horizontal) plane at a speed relative to the other during printing. This movement is typically achieved by one of the printing conditions described above, such as moving a printing platform on which the substrate is disposed, moving the nozzle of the apparatus, or both. Though referencing movement of the substrate and/or nozzle, this movement speed is typically described as the “nozzle speed”, and may be referred to as such herein. Like the nozzle height, the nozzle speed may be a secondary parameter, i.e., is not itself selected, but rather is controlled by or linked to another selected (i.e., primary) printing parameter, as described below. Typically, the nozzle speed is in the range of from 1 to 200 mm/s, such as from 1 to 100, 5 to 150, 10 to 100, or 15 to 50 mm/s. However, in some embodiments, the nozzle speed varies (i.e., increases and/or decreases) during printing, e.g. based on another printing parameter, a real-time adjustment, etc.

The first composition is described in further detail herein, and is to be understood in view of the description and examples below relating to first composition itself as well as “the compositions” described further below. Generally, the first composition may be any composition suitable for use in forming a 3D pattern or article via printing.

The properties of the first composition may vary, and are typically dependent on the particular composition(s) utilized in the first composition. For example, the viscosity of the first composition may be any viscosity suitable for printing. In certain embodiments, the viscosity of the first composition may be defined as a dynamic viscosity, which may be in the range of from 500 to 10,000,000 centipoise (cP), such as from 30,000 to 5,000,000, or from 30,000 to 2,000,000, from 30,000 to 1,000,000, from 30,000 to 800,000, from 30,000 to 500,000, or from 80,000 to 500,000, cP, where 1 cP is equal to 1 mPa-s. Viscosity values herein are at 25° C. unless otherwise expressly indicated. The viscosity of the first composition may be altered (i.e. increased or decreased) by heating or cooling the first composition, e.g. via heat transfer to or from the nozzle or the substrate, altering the ambient conditions, etc., as described below. Likewise, the elastic modulus of the first composition may vary, e.g. based on the particular printing parameters selected, the compositions employed, the 3D pattern or article to be formed, etc. Additionally, the elastic modulus of the first composition may change over time, e.g. due to curing, crosslinking, and/or hardening of the first composition, including during the method. In specific embodiments, the first composition is a paste, especially a curable paste.

The first composition is passed through the cavity of the nozzle and expelled (e.g. extruded or dispensed) from the nozzle tip. Accordingly, the dimensions (i.e., cross sectional shape, height, width, diameter, etc.) of the first composition as printed are typically influenced and/or dictated by the perimeter shape and/or dimensions of the cavity. Likewise, the form of the first composition during printing may also be selected and influenced and/or dictated by the nozzle, as described in further detail below.

The first composition may be printed on the substrate in any form, based on the desired characteristics of the pattern or layer as described above.

As introduced above, the first composition is passed through the cavity of the nozzle and expelled (e.g. extruded) from the nozzle tip. Accordingly, the overall shape of the cavity can, in conjunction with the elastic modulus of the first composition, influence and/or dictate dimensions of the pattern or layer or first formed from the first composition. For example, the nozzle may be a reducing tip (i.e., having a tip ID (di) less than a base ID), such that the first composition is radially compressed while passed through the nozzle. In such instances, the viscoelastic properties, if any, of the first composition and the extrusion speed will dictate the degree to which the first composition will decompress to an outer diameter greater than the tip ID (di) of the nozzle. Additionally, as described in further detail below, a shape of an outer portion of the nozzle (e.g. at the tip) may influence a dimension and/or shape of the first composition exiting the nozzle.

Ambient conditions may be manipulated or controlled during (I) printing the first composition. For example, if desired, the substrate may be heated, cooled, mechanically vibrated, or otherwise manipulated before, during, and/or after the steps of printing to assist with solidification and/or curing. Further, the substrate may be moved, e.g. rotated, during any printing step. Similarly, the nozzle, or a dispenser connected thereto, may be heated or cooled before, during, and after dispensing the first composition. Likewise, more than one dispenser may be utilized with each dispenser having independently selected properties or parameters. The method may be carried out in a heated and/or humidified environment such that solidification and/curing initiates after each step of printing.

During (I) printing the first composition, the nozzle and the substrate are spaced a distance from one another in the Z-axis (vertical) plane, as measured from a top surface of the substrate and the tip of the nozzle. This distance between the nozzle tip and the top surface of the substrate is typically described as the “nozzle height”, and may be referred to as such herein. For example, the nozzle height is typically measured at the beginning of the method as the distance, along the Z-axis, between the bottom-most portion of the nozzle tip and the portion of the substrate on which the first composition will first be printed.

Typically, the nozzle height is chosen based on myriad factors, e.g. dimensions of the nozzle, selection of the first composition and its properties (including viscosity), desired characteristics of the pattern or layer, desired dimensions of the 3D pattern or article being formed, etc., as described below. In these or other embodiments, the nozzle height is a secondary parameter, i.e., is not itself selected, but rather is controlled by or linked to another selected (i.e., primary) printing parameter, as described below. Typically, the nozzle height is in the range of from 1 to 2000 mm, such as from 1 to 9, 1 to 99, 10 to 99, or 100 to 2000 mm. However, in some embodiments, the nozzle height varies (i.e., increases and/or decreases) during printing, e.g. based on another printing parameter, a real-time adjustment, etc. The nozzle height and/or speed may be measured and/or determined by any technique, such as via manual measurements (e.g. those utilizing a height gauge, ruler, etc.), optical measurements (e.g. those utilizing optical sensors, such as intensity-based sensors, triangulation-based sensors, time-of-flight-based sensors, Doppler sensors etc., scanning inferometry, fiber Bragg gratings, etc.), and/or computation measurements (e.g. those utilizing 3D printing software), and the like, as well as combinations and/or modifications thereof.

The method comprises, (V) during (IV) printing, implementing a correction signal to adjust a flow rate of the first composition to minimize the dimensional differences between the desired characteristics of the pattern or layer and the actual or predicted characteristics of the pattern or layer.

The correction signal is a feedforward correction signal rather than a feedback correction signal. The correction signal is used to adjust the volumetric flowrate of the first composition in real time during printing of the first composition to form the pattern or layer. Based on the correction signal, the flow rate of the first composition is reduced during deceleration of the substrate and/or the nozzle, and the flow rate of the first composition is increased during acceleration of the substrate and/or the nozzle, by an amount determined by the need to compensate for the determined dimensional differences between the desired characteristics of the pattern or layer and the actual or predicted characteristics of the pattern or layer.

The correction signal can be any alteration from standard correction signals that adjust flowrate profile linearly proportional to nozzle speed that is determined to be effective, and is a function of step (Ill) of the method. The correction signal can be generated through computational iterations, or computational/machine learning iterations to minimize or eliminate dimensional differences between desired characteristics of a pattern or layer and the actual characteristics of the printed pattern or layer. In certain embodiments, the method can be further optimized by combining with in situ measurement of printing results providing real time feedback inputs. As more printing is performed and more data is gathered, the method can also utilize machine learning from the data to become even more accurate. The correction signal can also be generated by machine learning only without using computational fluid dynamics modeling.

In certain embodiments, step (V) includes generating the correction signal through computational iterations, or computational iteration/machine learning iterations to minimize or eliminate dimensional differences between desired characteristics of a pattern or layer and the actual characteristics of the pattern or layer.

For example, in certain embodiments, use of the inventive method including the correction signal can reduce dimensional differences between the desired characteristics of the pattern or layer and the actual or predicted characteristics of the pattern or layer by at least 2, alternatively at least 4, alternatively at least 6, alternatively at least 8, alternatively at least 10, alternatively at least 12, alternatively at least 14, alternatively at least 16, alternatively at least 18, alternatively at least 20, alternatively at least 22, alternatively at least 24, alternatively at least 25, alternatively at least 26, alternatively at least 28, alternatively at least 30, alternatively at least 32, alternatively at least 34, alternatively at least 36, alternatively at least 38, alternatively at least 40, alternatively at least 42, alternatively at least 44, alternatively at least 46, alternatively at least 48, alternatively at least 50, percent as compared to the dimensional differences between the desired characteristics of the pattern or layer and the actual or predicted characteristics of an identical pattern or layer formed without steps (Ill) and (V). These values refer to a maximum deviation of dimensional differences between the desired characteristics of the pattern or layer and the actual or predicted characteristics of the pattern or layer. Byway of example, if the desired characteristics of the pattern or layer include a filament having a consistent diameter throughout its length, the maximum deviation of dimensional differences between the desired characteristics of the pattern or layer and the actual or predicted characteristics of the pattern or layer would be the point at which the filament had the greatest diameter (or the smallest diameter) as compared to the target diameter in the desired characteristics. In a specific embodiment, the pattern or layer comprises a filament, and the filament has a substantially constant diameter, including around any turns and/or intersecting points in the pattern or layer. By substantially constant diameter, it is meant that the diameter deviates a maximum amount of less than 10, alternatively less than 9, alternatively less than 8, alternatively less than 7, alternatively less than 6, alternatively less than 5, alternatively less than 4, alternatively less than 3, alternatively less than 2, alternatively less than 1, percent based on a target or desired diameter.

As introduced above, the apparatus may comprise components in addition to those responsible for printing the first composition. For example, the apparatus may comprise, or be operatively connected to or in electronic communication with, a sensor (e.g. camera, laser displacement sensor, detector, etc.) and/or a control system.

In certain embodiments, the apparatus comprises the sensor. In specific embodiments, the sensor can be used to measure pressure in the positive displacement pump, optionally at each of the inlet and the outlet of the positive displacement pump. The sensor may alternatively or additionally be utilized for any other purpose. Accordingly, the sensor is not limited, and may be any device suitable for measuring any desired parameter or property. The sensor may be integral with the apparatus or incorporated as a stand-alone device. Moreover, the sensor may itself be a system comprising various components (e.g. cameras, detectors, lasers, etc.), or may comprise a plurality of sensors that are the same as or different from one another.

In some embodiments, the apparatus comprises the control system. In such embodiments, the control system is used to control one or more components of the apparatus. Accordingly, the control system is not limited, and may be a stand-alone control unit or a combination of separate components (e.g. computers, controllers, etc.).

In certain embodiments, the apparatus itself includes one or more embedded sensors and an onboard computer, in addition to the various 3D-printing components (e.g. hardware). In these embodiments, the sensors, the computer, and the 3D-printing hardware are arranged in a closed-loop feedback configuration capable of adjusting printing parameters (e.g. in real-time) in response to certain inputs. The inputs may include data generated by the sensor. Use of such a real time feedback loop may be utilized in combination with the correction signal described above, but is not utilized alone, i.e., without sue of steps (Ill) and (V). Such a feedback loop may control the 3D-printing hardware to adjust one or more printing parameters, such as the volumetric flow rate (Q).

The sensors may include optical and/or positional sensors for determining and/or measuring the nozzle height (t), the nozzle speed (v), a pattern or layer height, etc., as described above, or combinations thereof. Additionally, or alternatively, the apparatus may comprise a camera in communication with a computer configured to perform an image analysis to measure and/or determine one or more positional and/or spatial evaluations (e.g. to determine a height, width, length, shape, etc.) of one or more portions of the 3D-object being printed, such as a pattern or layer or filament thereof. In this fashion, (II) controlling the volumetric flow rate may comprise utilizing a closed-loop feedback control system comprising the control system and the sensor described above.

The method may optionally comprise repeating (I)-(V) with independently selected composition(s) to form any additional pattern(s) or layer(s). For example, in certain embodiments, the method further comprises printing a second composition to form a second pattern or layer on the pattern or layer. In these embodiments, the second composition may be printed in the same manner, or in a different manner, than the first composition. However, any description above relative to steps (I)-(V) to form the pattern or layer is also applicable to printing the second composition on the pattern or layer to form the second pattern or layer thereon, and each aspect of each printing step is independently selected. Depending on the desired shape of the 3D pattern or article, the second pattern or layer may build on the pattern or layer selectively, or completely. The second composition may be the same as or different from the first composition utilized to form the pattern or layer, as described in further detail below. Similarly, additional patterns and/or layers may be formed utilizing additional compositions, as described below, with the printing steps described above.

The total number of patterns and/or layers required will depend, for example, on the size and shape of the 3D pattern or article, as well as dimensions of the individual and collective patterns and/or layers. One of ordinary skill can readily determine how many patterns and/or layers are required or desired using conventional techniques, such as 3D scanning, rendering, modeling (e.g. parametric and/or vector based modeling), sculpting, designing, slicing, manufacturing and/or printing software. In certain embodiments, once the 3D pattern or article is in a final solidified or cured state, the individual patterns or layers may not be identifiable.

The pattern or layer and any additional (e.g. subsequent or latter) pattern(s) or layer(s), optionally included as described below, are referred to collectively herein as “the layers,” “the patterns,” or “the patterns and layers.” In this sense, “the patterns and layers” is used herein in plural form to relate to the patterns and/or layers at any stage of the method, e.g. in an unsolidified and/or uncured state, in a partially solidified and/or partially cured state, in a solidified or a final cure state, etc. Generally, any description below relative to a particular pattern or layer is also applicable to any other pattern or layer, as the patterns and/or layers are independently formed and selected.

The patterns and/or layers can each be of various dimension, including thickness and width. Thickness and/or width tolerances of the patterns and/or layers may depend on the 3D printing process used, with certain printing processes having high resolutions and others having low resolutions. Thicknesses of the patterns and/or layers can be uniform or may vary, and average thicknesses of the patterns and/or layers can be the same or different. Average thickness is generally associated with thickness of the pattern or layer immediately after printing. In various embodiments, the patterns and/or layers independently have an average thickness of from about 1 to about 10,000 μm, such as from about 2 to about 1,000, about 5 to about 750, about 10 to about 500, about 25 to about 250, or about 50 to 100 μm. Thinner and thicker thicknesses are also contemplated. This disclosure is not limited to any particular dimensions of any of the patterns and/or layers. As understood in the art, a pattern or layer thickness and/or width may be measured and/or determined by any technique, such as via manual measurements (e.g. those utilizing a thickness gauge, caliper, micrometer, ruler, etc.), optical measurements (e.g. those utilizing optical sensors, such as intensity-based sensors, triangulation-based sensors, time-of-flight-based sensors, Doppler sensors etc., scanning inferometry, fiber Bragg gratings, etc.), and/or computation measurements (e.g. those utilizing 3D printing software), and the like, as well as combinations and/or modifications thereof. Typically, a thickness of a particular pattern or layer is measured from opposing portions thereof, such as the distance between a first portion adjacent the substrate on which the particular pattern or layer is disposed and a second portion opposite the first portion. In this fashion, pattern or layer thickness may be measured only in the Z-axis. However, in instances where adjacent layers are off-set with respect to one another in the X-Y plane (i.e., off-set rather than completely “stacked” in the Z-axis), the pattern or layer thickness may likewise be measured in an off-set fashion.

Typically, the patterns and/or layers are substantially free from voids. However, in certain embodiments each of the patterns and/or layers may have a randomized and/or a selectively solidified pattern, regardless of the form of the patterns and/or layers.

If desired, inserts, which may have varying shape, dimension, and may comprise any suitable material, may be disposed or placed on or at least partially in any pattern or layer during the method. For example, an insert may be utilized in between subsequent printing steps, and the insert may become integral with the 3D pattern or article upon its formation. Alternatively, the insert may be removed at any step during the method, e.g. to leave a cavity or for other functional or aesthetic purposes. The use of such inserts may provide better aesthetics and economics over relying on printing alone.

Finally, the method comprises (VI) exposing pattern(s) and/or layer(s) to a solidification condition. The solidification condition may be any condition which contributes to solidification of the pattern or layer, any additional or subsequent layer(s). For example, solidification may be a result of curing or increasing a crosslink density of the pattern(s) and/or layer(s). Alternatively, solidification may be the result of a physical change within a pattern or layer, e.g. drying or removing any vehicle which may be present in any of the composition and/or corresponding pattern(s) and/or layer(s), as described below with respect to suitable compositions. Because each pattern or layer is independently selected, the solidification condition may vary for each pattern or layer.

Depending on a selection of the particular composition, as described below, the solidification condition may be selected from: (i) exposure to moisture; (ii) exposure to heat; (iii) exposure to irradiation; (iv) reduced ambient temperature; (v) exposure to solvent; (vi) exposure to mechanical vibration; (vii) exposure to oxygen; (viii) a certain length of time lapse, or (ix) a combination of (i) to (viii). The solidification condition typically at least partially solidifies, alternatively solidifies, the patterns and/or layers.

The patterns and/or layers may be exposed to the solidification condition at any time in the method, and exposure to the solidification condition need not be delayed until two or more layers are formed in the method. For example, each pattern or layer may be exposed to the solidification condition individually, or all of the patterns and/or layers may be exposed to the solidification condition collectively. Specifically, the pattern or layer may be exposed to the solidification condition to at least partially solidify the pattern or layer prior to forming the second pattern or layer thereon. Similarly, the second pattern or layer may be at least partially solidified prior to repeating any printing steps for additional layers. The patterns and/or layers may also be subjected or exposed to a solidification condition when in contact with one another, even if these layers were at least partially solidified iteratively prior to each printing step.

At least partial solidification of the pattern or layer is generally indicative of cure; however, cure may be indicated in other ways, and solidification may be unrelated to curing. For example, curing may be indicated by a viscosity increase, e.g. bodying of the pattern or layer, an increased temperature of the pattern or layer, a transparency/opacity change of the pattern or layer, an increased surface or bulk hardness, etc. Generally, physical and/or chemical properties of the pattern or layer are modified as each pattern or layer at least partially solidifies to provide the at least partially solidified layers, respectively.

In certain embodiments, “at least partially solidified” means that the particular at least partially solidified pattern or layer substantially retains its shape upon exposure to ambient conditions. Ambient conditions refer to at least temperature, pressure, relative humidity, and any other condition that may impact a shape or dimension of the at least partially solidified layer. For example, ambient temperature is room temperature. Ambient conditions are distinguished from solidification conditions, where heat (or elevated temperature) is applied. By “substantially retains its shape,” it is meant that a majority of the at least partially solidified pattern or layer retains its shape, e.g. the at least partially solidified pattern or layer does not flow or deform upon exposure to ambient conditions. Substantially may mean that at least about 50%, 60%, 70%, 80%, 90%, 95%, 96%, 97%, 98%, 99%, 99.5%, 99.9%, 99.99%, or at least about 99.999% or more of the volume of the at least partially solidified pattern or layer is maintained in the same shape and dimension over a period of time, e.g. after 1 minute, 5 minutes, 10 minutes, 30 minutes, 1 hour, 4 hours, 8 hours, 12 hours, 1 day, 1 week, 1 month, etc. Said differently, substantially retaining shape means that gravity does not substantially impact shape of the at least partially solidified pattern or layer upon exposure to ambient conditions. The shape of the at least partially solidified pattern or layer may also impact whether the at least partially solidified pattern or layer substantially retains its shape. For example, when the at least partially solidified pattern or layer is rectangular or has another simplistic shape, the at least partially solidified pattern or layer may be more resistant to deformation at even lesser levels of solidification than at least partially solidified layers having more complex shapes.

More specifically, prior to exposing one or more layers to the solidification condition, the first composition (as well as the second composition and any subsequent compositions) is generally flowable and may be in the form of a liquid, slurry, or gel, alternatively a liquid or slurry, alternatively a liquid. Viscosity of each composition can be independently adjusted depending on the type of 3D printer and its dispensing technique or other considerations. Adjusting viscosity can be achieved, for example, by heating or cooling any of the compositions, adjusting molecular weight of one or more components thereof, by adding or removing a solvent, carrier, and/or diluent, by adding a filler or thixotroping agent, etc.

When the pattern or layer is at least partially solidified prior to printing the second composition, printing of the second composition to form the second pattern or layer occurs before the at least partially solidified pattern or layer has reached a final solidified state, i.e., while the at least partially solidified pattern or layer is still deformable. In this sense, the at least partially solidified pattern or layer is also “green.” As used herein, the term “green” is used in accordance with its conventional understanding in the art to encompass a partial solidified and/or a partial cure but not a final solidified and/or cure state. The distinction between partial solidification and/or cure state and a final solidification and/or cure state is whether the partially solidified and/or cured pattern or layer can undergo further solidification, curing and/or crosslinking. Functional groups of the components of the first composition may be present even in the final solidified and/or cure state, but may remain unreacted due to steric hindrance or other factors.

In these embodiments, printing of the patterns and/or layers may be considered “wet-on-wet” such that the adjacent layers at least physically bond, and may also chemically bond, to one another. For example, in certain embodiments, depending on a selection of the compositions, components in each of the patterns and/or layers may chemically cross-link/cure across the print line. In certain embodiments, the first composition has a skin-over time greater than a print time of the first layer, such that the pattern or layer remains green after formation. In these embodiments, the second pattern or layer is formed on the pattern or layer within the skin-over time of the first composition, such that the first and second layers chemically cross-link/cure with one another. There may be certain advantages in having the cross-link network extend across the print line in relation to longevity, durability and appearance of the 3D pattern or article. The patterns and/or layers may also be formed around one or more substructures that can provide support or another function of the 3D pattern or article. In other embodiments, the compositions are not curable such that the patterns and/or layers are merely physically bonded to one another in the 3D pattern or article.

When the patterns and/or layers are applied wet-on-wet, and/or when the patterns and/or layers are only partially solidified and/or partially cured, any iterative steps of exposing the patterns and/or layers to the curing and/or solidification condition may effect cure of more than just the previously printed layer. As noted above, because the cure may extend beyond or across the print line, and because a composite including the patterns and/or layers is typically subjected to the solidification condition, any other partially cured and/or solidified layers may also further, alternatively fully, cure and/or solidify upon a subsequent step of exposing the patterns and/or layers to a curing and/or solidification condition. By way of example, the method may comprise printing the second composition to form the second pattern or layer on the at least partially solidified first layer. Prior to printing another composition to form another pattern or layer on the second layer, the second pattern or layer may be exposed to a solidification condition such that printing another composition to form another pattern or layer on the second pattern or layer comprises printing another composition to form another pattern or layer on an at least partially solidified second layer.

However, in such an embodiment, exposing the second pattern or layer to the solidification condition may, depending on the selection of the first and second compositions, also further cure and/or solidify the at least partially solidified first layer. The same is true for any additional or subsequent layers

Further, if desired, a composite including all or some of the patterns and/or layers may be subjected to a final solidification step, which may be a final cure step. For example, to ensure that the 3D pattern or article is at a desired solidification state, a composite formed by printing and at least partially solidifying the patterns and/or layers may be subjected to a further step of solidification or further steps of solidification where layers may solidify under different types of solidification conditions. The final solidification step, if desired, may be the same as or different from any prior solidification steps, e.g. iterative solidification steps associated with each or any layer.

The substrate composition, the first composition, the second composition, and any subsequent or additional compositions utilized to print subsequent or additional layers, are independently selected and may be the same as or different from one another. For purposes of clarity, reference below to “the composition” or “the compositions” is applicable each of the substrate composition, the first composition, the second composition, and/or any subsequent or additional compositions utilized to print subsequent or additional layers, and are thus not to be construed as requiring any of the particular compositions to be the same as any other composition.

In certain embodiments, at least one of the compositions, e.g. the substrate composition, the first composition, the second composition, and/or any subsequent or additional compositions, comprises: (a) a resin; (b) a silicone composition; (c) a metal; (d) a slurry; or (e) a combination of (a) to (d).

In certain embodiments, at least one of the compositions, e.g. the substrate composition, the first composition, the second composition, and/or any subsequent or additional compositions, comprises the resin. As will be understood in view of the description herein, the resin may comprise, alternatively may be, an organic resin, a silicone resin, or combinations thereof. Specific examples of suitable organic resins are described below with general respect to the resin, and specific examples of suitable silicone resins are described further below with respect to various components of the silicone composition. In this sense, the silicone resins exemplified for use in the silicone composition may additionally or alternatively used in or as the resin in any of the compositions described herein.

The term “resin” is conventionally used to describe a composition that comprises a polymer (e.g. natural or synthetic) and is capable of being cured and/or hardened (i.e., the resin comprises the composition in an uncured and/or unhardened state). However, the term “resin” is also conventionally used to denote a composition comprising a natural or synthetic polymer in a cured and/or hardened state. As such, the term “resin” may be used in either conventional sense to refer to a cured and/or hardened resin, or to an uncured and/or unhardened resin. Accordingly, as used herein, the general term “resin” may refer to a cured or an uncured resin, and the more specific terms “cured resin” and “uncured resin” are used to differentiate between a particular resin in a cured or uncured state. It is also to be understood that the term “uncured” refers to a composition or component that is not fully cross-linked and/or polymerized, as described below. For example, and “uncured” resin may have undergone little to no crosslinking, or may be cross-linked at an amount of less than 100% of available cure sites, e.g. at an amount of from about 10 to about 98, about 15 to about 95, about 20 to about 90, about 20 to about 85, or about 20 to about 80% of available cure sites. Conversely, the term “cured” may refer to the composition when it is completely cross-linked, or has undergone enough crosslinking to achieve a property or characteristic typically ascribed to a cured composition. However, some of the available cure sites in a cured composition may remain uncross-linked. Likewise, it is to be understood that some of the available cure sites in an uncured composition may be cross-linked. Thus, the terms “cured” and “uncured” may be understood to be functional and/or descriptive terms. For example, a cured resin is typically characterized by an insolubility in organic solvents, an absence of liquid and/or plastic flow under ambient conditions, and/or a resistance to deformation in response to an applied force. In contrast, an uncured resin is typically characterized by a solubility in organic solvents, an ability to undergo liquid and/or plastic flow, and/or an ability to be deformed in response to an applied force (e.g. effected by the printing process). In some embodiments, the composition comprises an uncured resin. In such embodiments, the uncured resin may be present in the composition in an uncured state, but may be capable of being cured (e.g. via reaction of the uncured resin with another component of the composition, via exposure to a curing condition, etc.). The uncured resin, once cured, may no longer be deformable.

Generally, examples of suitable resins comprise reaction products of monomeric units (e.g. monomers, oligomers, polymers, etc.) and curing agents. Curing agents suitable for use in forming such resins typically include at least difunctional molecules that are reactive with functional groups present in the resin-forming monomeric unit. For example, curing agents suitable for use in forming epoxy resins are typically at least difunctional molecules that are reactive with epoxide groups (i.e., comprise two or more epoxide-reactive functional groups). As understood in the art, the terms “curing agent” and “cross-linking agent” can be used interchangeably. Additionally, the curing agent may itself be a monomeric unit, such that resin comprises a reaction product of at least two monomeric unites, which may be the same as or different from one another.

Suitable resins are conventionally named/identified according to a particular functional group present in the reaction product. For example, the term “polyurethane resin” represents a polymeric compound comprising a reaction product of an isocyanate (i.e., a monomeric unit comprising isocyanate functionality) and a polyol (i.e., a chain extender/curing agent comprising alcohol functionalities). The reaction of the isocyanate and the polyol create urethane functional groups, which were not present in either of the unreacted monomer or curing agent. In certain instances, however, resins are named according to a particular functional group present in the monomeric unit (i.e., the functionality at a cure site). For example, the term “epoxy resin” represents a polymeric compound comprising a cross-linked reaction product of a monomeric unit having one or more epoxide groups (i.e., epoxide functionalities) and a curing agent. However, once cured, the epoxy resin is no longer an epoxy, or no longer includes epoxide groups, but for any unreacted or residual epoxide groups (i.e., cure sites), which may remain after curing, as understood in the art. In other instances, however, suitable resins may comprise the reaction product of one or more monomeric units (i.e., where the curing agent itself is also a monomeric unit), each having the same functionality both prior to and after the reaction. In such instances, the resins may be named according to a functional group present in both the monomeric unit and the reaction product (e.g. an unreacted functional group, or a functional group that is modified during reaction but does not change in kind/name). For example, the term “silicone resin” represents a siloxane-functional polymeric compound comprising a reaction product of a monomeric unit comprising a siloxane functional group. Certain examples of suitable resins comprise long chain thermoplastics such as thermoplastic elastomers (TPE), and reaction products of monomeric units (e.g. monomers, oligomers, polymers, etc.) and curing agents.

In some embodiments, the resin comprises a thermosetting and/or thermoplastic resin. The terms “thermosetting” and “thermoplastic” are used herein the conventional sense, any may thus be understood as descriptive and/or functional characterizations of particular resins. By way of example, the term “thermoplastic” typically describes a resin (e.g. a plastic) that becomes pliable and/or moldable above a specific temperature (e.g. transition temperature, such as a Tg), and also solidifies upon cooling below a specific temperature. Moreover, a “thermoplastic” can typically be remolded into a new shape, e.g. after heating a molded thermoplastic article above the specific temperature to regain pliability prior to and/or during remolding. In contrast, the term “thermoset” typically describes a resin (e.g. a plastic) that is irreversibly cured from a soft solid or viscous liquid (e.g. an uncured resin). As such, once cured/hardened, a “thermoset” typically cannot be remolded into a new shape via reheating (e.g. to do comprising a Tg greater than a temperature at which the thermoset loses one or more material properties and/or decomposes).

Specific examples of suitable resins typically include polyamides (PA), such as Nylons; polyesters such as polyethylene terephthalates (PET), polybutylene terephthalates (PET), polytrimethylene terephthalates (PTT), polyethylene naphthalates (PEN), liquid crystalline polyesters, and the like; polyolefins such as polyethylenes (PE), polypropylenes (PP), polybutylenes, and the like; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones (PEK); polyetheretherketones (PEEK); polyetherketoneketones (PEKK); polyarylates (PAR); polyethernitriles (PEN); resol-type; urea (e.g. melamine-type); phenoxy resins; fluorinated resins, such as polytetrafluoroethylenes; thermoplastic elastomers, such as polystyrene types, polyolefin types, polyurethane types, polyester types, polyamide types, polybutadiene types, polyisoprene types, fluoro types, and the like; and copolymers, modifications, and combinations thereof. Additionally, elastomers and/or rubbers can be added to or compounded with the resin, e.g. to improve certain properties in the uncured resin, such as deformability, cure time, etc., and/or in the cured resin (and thus the 3D pattern or article), such as flexibility, impact strength, etc. In some embodiments, the resin may be disposed in a vehicle or solvent.

In certain embodiments, at least one of the compositions, e.g. the substrate composition, the first composition, the second composition, and/or any subsequent or additional compositions, comprises the silicone composition, which may be a rubber or elastomer silicone composition. In such embodiments, the 3D pattern or article may be utilized in biological and/or health care applications in view of the excellent compatibility between silicones and biological systems. Suitable silicone compositions may be independently selected from (a) hydrosilylation-curable silicone compositions; (b) condensation-curable silicone compositions; (c) thiol-ene reaction-curable silicone compositions; (d) free-radical-curable silicone compositions; and (e) ring-opening reaction curable silicone compositions. Dual cure compositions utilizing two curing mechanisms in one composition can also be utilized. In these embodiments, the silicone compositions are generally curable such that exposure to the solidification condition may be referred to as exposure to a curing condition. As understood in the art, these silicone compositions may be cured via different curing conditions, such as exposure to moisture, exposure to heat, exposure to irradiation, etc. Moreover, these silicone compositions may be curable upon exposure to different types of curing conditions, e.g. both heat and irradiation, which may be utilized together or as only one. In addition, exposure to a curing condition may cure or initiate cure of different types of silicone compositions. For example, heat may be utilized to cure or initiate cure of condensation-curable silicone compositions, hydrosilylation-curable silicone compositions, and free radical-curable silicone compositions.

The silicone compositions may have the same cure mechanism upon application of the curing condition, but may still be independently selected from one another. For example, the first composition may comprise a condensation-curable silicone composition, and the second composition may also comprise a condensation-curable silicone composition, wherein the condensation-curable silicone compositions differ from one another, e.g. by components, relative amounts thereof, etc.

In certain embodiments, each of the silicone compositions utilized in the method cures via the same cure mechanism upon application of the curing condition. These embodiments easily allow for cure across the print line, if desired, as the components of in each of the silicone compositions may readily react with one another in view of having the same cure mechanism upon application of the curing condition. In these embodiments, each of the silicone compositions may still differ from one another in terms of the actual components utilized and relative amounts thereof, even though the cure mechanism is the same in each of the silicone compositions. In contrast, although there may be some cure across the print line when each of the patterns and/or layers cures via a different mechanism (e.g. hydrosilylation versus condensation), components in these layers may not be able to react with one another upon application of the curing condition, which may be desirable in other applications.

In certain embodiments, at least one of the silicone compositions comprises a hydrosilylation-curable silicone composition. In these embodiments, the hydrosilylation-curable silicone composition typically comprises: (A) an organopolysiloxane having an average of at least two silicon-bonded alkenyl groups or silicon-bonded hydrogen atoms per molecule; (B) an organosilicon compound having an average of at least two silicon-bonded hydrogen atoms or silicon-bonded alkenyl groups per molecule capable of reacting with the silicon-bonded alkenyl groups or silicon-bonded hydrogen atoms in the organopolysiloxane (A); and (C) a hydrosilylation catalyst. When the organopolysiloxane (A) includes silicon-bonded alkenyl groups, the organosilicon compound (B) includes at least two silicon-bonded hydrogen atoms per molecule, and when the organopolysiloxane (A) includes silicon-bonded hydrogen atoms, the organosilicon compound (B) includes at least two silicon-bonded alkenyl groups per molecule. The organosilicon compound (B) may be referred to as a cross-linker or cross-linking agent. In certain embodiments, the organopolysiloxane (A) and/or the organosilicon compound (B) may independently include more than two hydrosilylation-reactive functional groups (e.g. silicon-bonded alkenyl groups and/or silicon-bonded hydrogen atoms per molecule, such as an average of 3, 4, 5, 6, or more hydrosilylation-reactive functional groups per molecule. In such embodiments, the hydrosilylation-curable silicone composition may be formulated to be chain-extendable and cross-linkable via hydrosilylation, such as by differing the number and/or type of hydrosilylation-reactive functional groups per molecule of the organopolysiloxane (A) from the number and/or type of hydrosilylation-reactive functional groups per molecule of the organosilicon compound (B). For example, in these embodiments, when the organopolysiloxane (A) includes at least two silicon-bonded alkenyl groups per molecule, the organosilicon compound (B) may include at least three silicon-bonded hydrogen atoms per molecule, and when the organopolysiloxane (A) includes at least two silicon-bonded hydrogen atoms, the organosilicon compound (B) may include at least three silicon-bonded alkenyl groups per molecule. Accordingly, the ratio of hydrosilylation-reactive functional groups per molecule of the organopolysiloxane (A) to hydrosilylation-reactive functional groups per molecule of the organosilicon compound (B) may be equal to, less than, or greater than 1:1, such as from 1:5 to 5:1, alternatively from 1:4 to 4:1, alternatively from 1:3 to 3:1, alternatively from 1:2 to 2:1, alternatively from 2:3 to 3:2, alternatively from 3:4 to 4:3.

The organopolysiloxane (A) and the organosilicon compound (B) may independently be linear, branched, cyclic, or resinous. In particular, the organopolysiloxane (A) and the organosilicon compound (B) may comprise any combination of M, D, T, and Q units. The symbols M, D, T, and Q represent the functionality of structural units of organopolysiloxanes. M represents the monofunctional unit R⁰₃SiO_{1/2}. D represents the difunctional unit R⁰₂SiO_{2/2}. T represents the trifunctional unit R⁰SiO_{3/2}. Q represents the tetrafunctional unit SiO_{4/2}. Generic structural formulas of these units are shown below:

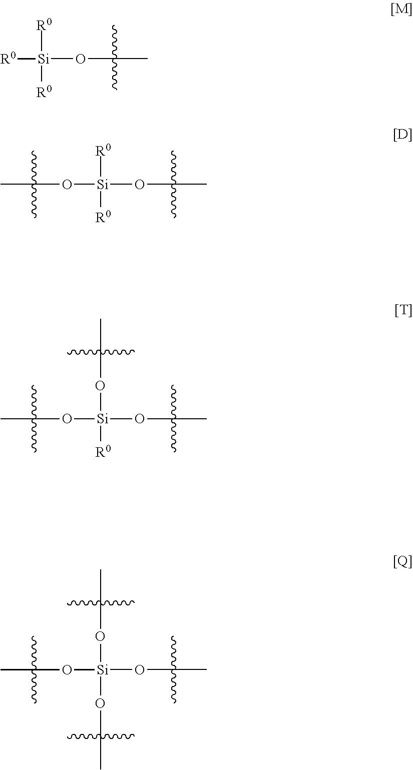

In these structures/formulae, each R⁰ may be any hydrocarbon, aromatic, aliphatic, alkyl, alkenyl, or alkynyl group.

The particular organopolysiloxane (A) and organosilicon compound (B) may be selected based on desired properties of the 3D pattern or article and layers during the method. For example, it may be desirable for the patterns and/or layers to be in the form of an elastomer, a gel, a resin, etc., and selecting the components of the silicone composition allows one of skill in the art to achieve a range of desirable properties.

For example, in certain embodiments, one of the organopolysiloxane (A) and the organosilicon compound (B) comprises a silicone resin, which typically comprises T and/or Q units in combination with M and/or D units. When the organopolysiloxane (A) and/or organosilicon compound (B) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the hydrosilylation-curable silicone composition comprises a resin, the pattern(s) and/or layer(s) and resulting 3D pattern or article have increased rigidity.

Alternatively, in other embodiments, the organopolysiloxane (A) and/or the organosilicon compound (B) is an organopolysiloxane comprising repeating D units. Such organopolysiloxanes are substantially linear but may include some branching attributable to T and/or Q units. Alternatively, such organopolysiloxanes are linear. In these embodiments, the pattern(s) and/or layer(s) and resulting 3D pattern or article are elastomeric.

The silicon-bonded alkenyl groups and silicon-bonded hydrogen atoms of the organopolysiloxane (A) and the organosilicon compound (B), respectively, may independently be pendent, terminal, or in both positions.

In a specific embodiment, the organopolysiloxane (A) has the general formula:

(R¹R²₂SiO_{1/2})_{w}(R²₂SiO_{2/2})ₓ(R²SiO_{3/2})_{y}(SiO_{4/2})_{z} (I)

wherein each R¹ is an independently selected hydrocarbyl group, which may be substituted or unsubstituted, and each R² is independently selected from R¹ and an alkenyl group, with the proviso that at least two of R² are alkenyl groups, and w, x, y, and z are mole fractions such that w+x+y+z=1. As understood in the art, for linear organopolysiloxanes, subscripts y and z are generally 0, whereas for resins, subscripts y and/or z>0. Various alternative embodiments are described below with reference to w, x, y and z. In these embodiments, the subscript w may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99. The subscript x typically has a value of from 0 to 0.9, alternatively from 0 to 0.45, alternatively from 0 to 0.25. The subscript y typically has a value of from 0 to 0.99, alternatively from 0.25 to 0.8, alternatively from 0.5 to 0.8. The subscript z typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

In certain embodiments, each R¹ is a C₁ to C₁₀ hydrocarbyl group, which may be substituted or unsubstituted, and which may include heteroatoms within the hydrocarbyl group, such as oxygen, nitrogen, sulfur, etc. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl groups, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl groups, such as cyclopentyl, cyclohexyl, and methylcyclohexyl; aryl groups, such as phenyl and naphthyl; alkaryl groups, such as tolyl and xylyl; and aralkyl groups, such as benzyl and phenethyl. Examples of halogen-substituted hydrocarbyl groups represented by R¹ include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

The alkenyl groups represented by R², which may be the same or different within the organopolysiloxane (A), typically have from 2 to 10 carbon atoms, alternatively from 2 to 6 carbon atoms, and are exemplified by, for example, vinyl, allyl, butenyl, hexenyl, and octenyl.

In these embodiments, the organosilicon compound (B) may be further defined as an organohydrogensilane, an organopolysiloxane an organohydrogensiloxane, or a combination thereof. The structure of the organosilicon compound (B) can be linear, branched, cyclic, or resinous. In acyclic polysilanes and polysiloxanes, the silicon-bonded hydrogen atoms can be located at terminal, pendant, or at both terminal and pendant positions. Cyclosilanes and cyclosiloxanes typically have from 3 to 12 silicon atoms, alternatively from 3 to 10 silicon atoms, alternatively from 3 to 4 silicon atoms. The organohydrogensilane can be a monosilane, disilane, trisilane, or polysilane.

Hydrosilylation catalyst (C) includes at least one hydrosilylation catalyst that promotes the reaction between the organopolysiloxane (A) and the organosilicon compound (B). The hydrosilylation catalyst (C) can be any of the well-known hydrosilylation catalysts comprising a platinum group metal (i.e., platinum, rhodium, ruthenium, palladium, osmium and iridium) or a compound containing a platinum group metal. Typically, the platinum group metal is platinum, based on its high activity in hydrosilylation reactions.

Specific hydrosilylation catalysts suitable for (C) include the complexes of chloroplatinic acid and certain vinyl-containing organosiloxanes disclosed by Willing in U.S. Pat. No. 3,419,593, the portions of which address hydrosilylation catalysts are hereby incorporated by reference. A catalyst of this type is the reaction product of chloroplatinic acid and 1,3-diethenyl-1,1,3,3-tetramethyldisiloxane.

The hydrosilylation catalyst (C) can also be a supported hydrosilylation catalyst comprising a solid support having a platinum group metal on the surface thereof. A supported catalyst can be conveniently separated from organopolysiloxanes, for example, by filtering the reaction mixture. Examples of supported catalysts include, but are not limited to, platinum on carbon, palladium on carbon, ruthenium on carbon, rhodium on carbon, platinum on silica, palladium on silica, platinum on alumina, palladium on alumina, and ruthenium on alumina.

In addition or alternatively, the hydrosilylation catalyst (C) can also be a microencapsulated platinum group metal-containing catalyst comprising a platinum group metal encapsulated in a thermoplastic resin. Hydrosilylation-curable silicone compositions including microencapsulated hydrosilylation catalysts are stable for extended periods of time, typically several months or longer, under ambient conditions, yet cure relatively rapidly at temperatures above the melting or softening point of the thermoplastic resin(s). Microencapsulated hydrosilylation catalysts and methods of preparing them are well known in the art, as exemplified in U.S. Pat. No. 4,766,176 and the references cited therein, and U.S. Pat. No. 5,017,654. The hydrosilylation catalyst (C) can be a single catalyst or a mixture comprising two or more different catalysts that differ in at least one property, such as structure, form, platinum group metal, complexing ligand, and thermoplastic resin.

The hydrosilylation catalyst (C) may also, or alternatively, be a photoactivatable hydrosilylation catalyst, which may initiate curing via irradiation and/or heat. The photoactivatable hydrosilylation catalyst can be any hydrosilylation catalyst capable of catalyzing the hydrosilylation reaction, particularly upon exposure to radiation having a wavelength of from 150 to 800 nanometers (nm).

Specific examples of photoactivatable hydrosilylation catalysts include, but are not limited to, platinum(II) p-diketonate complexes such as platinum(II) bis(2,4-pentanedioate), platinum(II) bis(2,4-hexanedioate), platinum(II) bis(2,4-heptanedioate), platinum(II) bis(1-phenyl-1,3-butanedioate, platinum(II) bis(1,3-diphenyl-1,3-propanedioate), platinum(II) bis(1,1,1,5,5,5-hexafluoro-2,4-pentanedioate); (η-cyclopentadienyl)trialkylplatinum complexes, such as (Cp)trimethylplatinum, (Cp)ethyldimethylplatinum, (Cp)triethylplatinum, (chloro-Cp)trimethylplatinum, and (trimethylsilyl-Cp)trimethylplatinum, where Cp represents cyclopentadienyl; triazene oxide-transition metal complexes, such as Pt[C₆H₅NNNOCH₃]₄, Pt[p-CN—C₆H₄NNNOC₆H₁₁]₄, Pt[p-H₃COC₆H₄NNNOC₆H₁₁]₄, Pt[p-CH₃(CH₂)ₓ—C₆H₄NNNOCH₃]₄, 1,5-cyclooctadiene·Pt[p-CN—C₆H₄NNNOC₆H₁₁]₂, 1,5-cyclooctadiene·Pt[p-CH₃O—C₆H₄NNNOCH₃]₂, [(C₆H₅)₃P]₃Rh[p-CN—C₆H₄NNNOC₆H₁₁], and Pd[p-CH₃(CH₂)ₓ—C₆H₄NNNOCH₃]₂, where x is 1, 3, 5, 11, or 17; (η-diolefin)(σ-aryl)platinum complexes, such as (η⁴-1,5-cyclooctadienyl)diphenylplatinum, η⁴-1,3,5,7-cyclooctatetraenyl)diphenylplatinum, (η⁴-2,5-norboradienyl)diphenylplatinum, (η⁴-1,5-cyclooctadienyl)bis-(4-dimethylaminophenyl)platinum, (η⁴-1,5-cyclooctadienyl)bis-(4-acetylphenyl)platinum, and (η⁴-1,5-cyclooctadienyl)bis-(4-trifluormethylphenyl)platinum. Typically, the photoactivatable hydrosilylation catalyst is a Pt(II) p-diketonate complex and more typically the catalyst is platinum(II) bis(2,4-pentanedioate). The hydrosilylation catalyst (C) can be a single photoactivatable hydrosilylation catalyst or a mixture comprising two or more different photoactivatable hydrosilylation catalysts.

The concentration of the hydrosilylation catalyst (C) is sufficient to catalyze the addition reaction between the organopolysiloxane (A) and the organosilicon compound (B). In certain embodiments, the concentration of the hydrosilylation catalyst (C) is sufficient to provide typically from 0.1 to 1000 ppm of platinum group metal, alternatively from 0.5 to 100 ppm of platinum group metal, alternatively from 1 to 25 ppm of platinum group metal, based on the combined weight of the organopolysiloxane (A) and the organosilicon compound (B).

The hydrosilylation-curable silicone composition may be a two-part composition where the organopolysiloxane (A) and organosilicon compound (B) are in separate parts. In these embodiments, the hydrosilylation catalyst (C) may be present along with either or both of the organopolysiloxane (A) and organosilicon compound (B). Alternatively still, the hydrosilylation catalyst (C) may be separate from the organopolysiloxane (A) and organosilicon compound (B) in a third part such that the hydrosilylation reaction-curable silicone composition is a three-part composition.

In one specific embodiment the hydrosilylation-curable silicone composition comprises ViMe₂(Me₂SiO)₁₂₈SiMe₂Vi as the organopolysiloxane (A), Me₃SiO(Me₂SiO)₁₄(MeHSiO)₁₆SiMe₃ as the organosilicon compound (B) and a complex of platinum with divinyltetramethyldisiloxane as (C) such that platinum is present in a concentration of 5 ppm based on (A), (B) and (C).

Solidification conditions for such hydrosilylation-curable silicone compositions may vary. For example, hydrosilylation-curable silicone composition may be solidified or cured upon exposure to irradiation and/or heat. One of skill in the art understands how selection of the hydrosilylation catalyst (C) impacts techniques for solidification and curing. In particular, photoactivatable hydrosilylation catalysts are typically utilized when curing via irradiation is desired.

In these or other embodiments, at least one of the silicone compositions comprises a condensation-curable silicone composition. In these embodiments, the condensation-curable silicone composition typically comprises (A′) an organopolysiloxane having an average of at least two silicon-bonded hydroxyl or hydrolysable groups per molecule; optionally (B′) an organosilicon compound having an average of at least two silicon-bonded hydrogen atoms, hydroxyl groups, or hydrolysable groups per molecule; and (C′) a condensation catalyst. Although any parameter or condition may be selectively controlled during the method or any individual step thereof, relative humidity and/or moisture content of ambient conditions may be selectively controlled to further impact a cure rate of condensation-curable silicone compositions.

The organopolysiloxane (A′) and the organosilicon compound (B′) may independently be linear, branched, cyclic, or resinous. In particular, the organopolysiloxane (A′) and the organosilicon compound (B′) may comprise any combination of M, D, T, and Q units, as with the organopolysiloxane (A′) and the organosilicon compound (B′) disclosed above.

The particular organopolysiloxane (A′) and organosilicon compound (B′) may be selected based on desired properties of the 3D pattern or article and layers during the method. For example, it may be desirable for the patterns and/or layers to be in the form of an elastomer, a gel, a resin, etc., and selecting the components of the silicone composition allows one of skill in the art to achieve a range of desirable properties.

For example, in certain embodiments, one of the organopolysiloxane (A′) and the organosilicon compound (B′) comprises a silicone resin, which typically comprises T and/or Q units in combination with M and/or D units. When the organopolysiloxane (A′) and/or organosilicon compound (B′) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the condensation-curable silicone composition comprises a resin, the pattern(s) and/or layer(s) and resulting 3D pattern or article have increased rigidity.

Alternatively, in other embodiments, the organopolysiloxane (A′) and/or the organosilicon compound (B′) is an organopolysiloxane comprising repeating D units. Such organopolysiloxanes are substantially linear but may include some branching attributable to T and/or Q units.

Alternatively, such organopolysiloxanes are linear. In these embodiments, the pattern(s) and/or layer(s) and resulting 3D pattern or article are elastomeric.

The silicon-bonded hydroxyl groups and silicon-bonded hydrogen atoms, hydroxyl groups, or hydrolysable groups of the organopolysiloxane (A′) and the organosilicon compound (B′), respectively, may independently be pendent, terminal, or in both positions.

As known in the art, silicon-bonded hydroxyl groups result from hydrolyzing silicon-bonded hydrolysable groups. These silicon-bonded hydroxyl groups may condense to form siloxane bonds with water as a byproduct.

Examples of hydrolysable groups include the following silicon-bonded groups: H, a halide group, an alkoxy group, an alkylamino group, a carboxy group, an alkyliminoxy group, an alkenyloxy group, or an N-alkylamido group. Alkylamino groups may be cyclic amino groups.

In a specific embodiment, the organopolysiloxane (A′) has the general formula:

(R¹R³₂SiO_{1/2})_{w′}(R³₂SiO_{2/2})_{x′}(R³SiO_{3/2})_{y′}(SiO_{4/2})_{z′} (II)

wherein each R¹ is defined above and each R³ is independently selected from R¹ and a hydroxyl group, a hydrolysable group, or combinations thereof with the proviso that at least two of R³ are hydroxyl groups, hydrolysable groups, or combinations thereof, and w′, x′, y′, and z′ are mole fractions such that w′+x′+y′+z′=1. As understood in the art, for linear organopolysiloxanes, subscripts y′ and z′ are generally 0, whereas for resins, subscripts y′ and/or z′>0. Various alternative embodiments are described below with reference to w′, x′, y′ and z′. In these embodiments, the subscript w′ may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99. The subscript x′ typically has a value of from 0 to 0.9, alternatively from 0 to 0.45, alternatively from 0 to 0.25. The subscript y′ typically has a value of from 0 to 0.99, alternatively from 0.25 to 0.8, alternatively from 0.5 to 0.8. The subscript z′ typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

As set forth above, the condensation-curable silicone composition further comprises the organosilicon compound (B′). The organosilicon compound (B′) may be linear, branched, cyclic, or resinous. In one embodiment, the organosilicon compound (B′) has the formula R¹_{q}SiX_{4-q}, wherein R¹ is defined above, X is a hydrolysable group, and q is 0 or 1.

Specific examples of organosilicon compounds (B′) include alkoxy silanes such as MeSi(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH₂═CHSi[O—N═C(CH₃)CH₂CH₃]₃; organoacetamidosilanes such as CH₃Si[NHC(═O)CH₃]₃ and C₆H₅Si[NHC(═O)CH₃]3; amino silanes such as CH₃Si[NH(C₄H₉)]₃ and CH₃Si(NHC₆H₁₁)₃; and organoaminooxysilanes.

The organosilicon compound (B′) can be a single silane or a mixture of two or more different silanes, each as described above. Also, methods of preparing tri- and tetra-functional silanes are well known in the art; many of these silanes are commercially available.

When present, the concentration of the organosilicon compound (B′) in the condensation-curable silicone composition is sufficient to cure (cross-link) the organopolysiloxane (A′). The particular amount of the organosilicon compound (B′) utilized depends on the desired extent of cure, which generally increases as the ratio of the number of moles of silicon-bonded hydrolysable groups in the organosilicon compound (B′) to the number of moles of silicon-bonded hydroxy groups in the organopolysiloxane (A′) increases. The optimum amount of the organosilicon compound (B′) can be readily determined by routine experimentation.

The condensation catalyst (C′) can be any condensation catalyst typically used to promote condensation of silicon-bonded hydroxy (silanol) groups to form Si—O—Si linkages. Examples of condensation catalysts include, but are not limited to, amines, complexes of metals (e.g. lead, tin, zinc, iron, titanium, zirconium) with organic ligands (e.g. carboxyl, hydrocarbyl, alkoxyl, etc.) In particular embodiments, the condensation catalyst (C′) can be selected from tin(II) and tin(IV) compounds such as tin dilaurate, tin dioctoate, dibutyltin dilaurate, dibutyltin diacetate, and tetrabutyl tin; and titanium compounds such as titanium tetrabutoxide. In these or other embodiments, the condensation catalyst (C′) may be selected from zinc-based, iron-based, and zirconium-based catalysts.

When present, the concentration of the condensation catalyst (C′) is typically from 0.1 to 10% (w/w), alternatively from 0.5 to 5% (w/w), alternatively from 1 to 3% (w/w), based on the total weight of the organopolysiloxane (A′) in the condensation-curable silicone composition.

When the condensation-curable silicone composition includes the condensation catalyst (C′), the condensation-curable silicone composition is typically a two-part composition where the organopolysiloxane (A′) and condensation catalyst (C′) are in separate parts. In this embodiment, the organosilicon compound (B′) is typically present along with the condensation catalyst (C′). Alternatively still, the condensation-curable silicone composition may be a three-part composition, where the organopolysiloxane (A′), the organosilicon compound (B′) and condensation catalyst (C′) are in separate parts.

Solidification conditions for such condensation-curable silicone compositions may vary. For example, condensation-curable silicone composition may be solidified or cured upon exposure to ambient conditions, a moisturized atmosphere, and/or heat, although heat is commonly utilized to accelerate solidification and curing.

In these or other embodiments, at least one of the silicone compositions comprises a free radical-curable silicone composition. In one embodiment, the free radical-curable silicone composition comprises (A″) an organopolysiloxane having an average of at least two silicon-bonded unsaturated groups and (C″) a free radical initiator.

The organopolysiloxane (A″) may be linear, branched, cyclic, or resinous. In particular, the organopolysiloxane (A″) may comprise any combination of M, D, T, and Q units, as with the organopolysiloxane (A′) and the organosilicon compound (B′) disclosed above.

The particular organopolysiloxane (A″) may be selected based on desired properties of the 3D pattern or article and layers during the method. For example, it may be desirable for the patterns and/or layers to be in the form of an elastomer, a gel, a resin, etc., and selecting the components of the silicone composition allows one of skill in the art to achieve a range of desirable properties.

For example, in certain embodiments, the organopolysiloxane (A″) comprises a silicone resin, which typically comprises T and/or Q units in combination with M and/or D units. When the organopolysiloxane (A″) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the hydrosilylation-curable silicone composition comprises a resin, the pattern(s) and/or layer(s) and resulting 3D pattern or article have increased rigidity.

Alternatively, in other embodiments, the organopolysiloxane (A″) comprises repeating D units. Such organopolysiloxanes are substantially linear but may include some branching attributable to T and/or Q units. Alternatively, such organopolysiloxanes are linear. In these embodiments, the pattern(s) and/or layer(s) and resulting 3D pattern or article are elastomeric.

The silicon-bonded unsaturated groups of the organopolysiloxane (A″) may be pendent, terminal, or in both positions. The silicon-bonded unsaturated groups may include ethylenic unsaturation in the form of double bonds and/or triple bonds. Exemplary examples of silicon-bonded unsaturated groups include silicon-bonded alkenyl groups and silicon-bonded alkynyl groups. The unsaturated groups may be bonded to silicon directly, or indirectly through a bridging group such as an alkylene group, an ether, an ester, an amide, or another group.

In a specific embodiment, the organopolysiloxane (A″) has the general formula:

(R¹R⁴₂SiO_{1/2})_{w″}(R⁴₂SiO_{2/2})_{x″}(R⁴SiO_{3/2})_{y″}(SiO_{4/2})_{z″} (III)

wherein each R¹ is defined above and each R⁴ is independently selected from R¹ and an unsaturated group, with the proviso that at least two of R⁴ are unsaturated groups, and w″, x″, y″, and z″ are mole fractions such that w″+x″+y″+z″=1. As understood in the art, for linear organopolysiloxanes, subscripts y“and z″ are generally 0, whereas for resins, subscripts y” and/or z″>0. Various alternative embodiments are described below with reference to w″, x″, y“and z”. In these embodiments, the subscript w″ may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99. The subscript x″ typically has a value of from 0 to 0.9, alternatively from 0 to 0.45, alternatively from 0 to 0.25. The subscript y″ typically has a value of from 0 to 0.99, alternatively from 0.25 to 0.8, alternatively from 0.5 to 0.8. The subscript z″ typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

The unsaturated groups represented by R⁴ may be the same or different and are independently selected from alkenyl and alkynyl groups. The alkenyl groups represented by R⁴, which may be the same or different, are as defined and exemplified in the description of R² above. The alkynyl groups represented by R⁴, which may be the same or different, typically have from 2 to about 10 carbon atoms, alternatively from 2 to 8 carbon atoms, and are exemplified by, but are not limited to, ethynyl, propynyl, butynyl, hexynyl, and octynyl.

The free radical-curable silicone composition can further comprise an unsaturated compound selected from (i) at least one organosilicon compound having at least one silicon-bonded alkenyl group per molecule, (ii) at least one organic compound having at least one aliphatic carbon-carbon double bond per molecule, (iii) at least one organosilicon compound having at least one silicon-bonded acryloyl group per molecule; (iv) at least one organic compound having at least one acryloyl group per molecule; and (v) mixtures comprising (i), (ii), (iii) and (iv). The unsaturated compound can have a linear, branched, or cyclic structure.

The organosilicon compound (i) can be an organosilane or an organosiloxane. The organosilane can be a monosilane, disilane, trisilane, or polysilane. Similarly, the organosiloxane can be a disiloxane, trisiloxane, or polysiloxane. Cyclosilanes and cyclosiloxanes typically have from 3 to 12 silicon atoms, alternatively from 3 to 10 silicon atoms, alternatively from 3 to 4 silicon atoms. In acyclic polysilanes and polysiloxanes, the silicon-bonded alkenyl group(s) can be located at terminal, pendant, or at both terminal and pendant positions.

Specific examples of organosilanes include, but are not limited to, silanes having the following formulae:

Vi₄Si,PhSiVi₃,MeSiVi₃,PhMeSiVi₂,Ph₂SiVi₂, and PhSi(CH₂CH═CH₂)₃,

wherein Me is methyl, Ph is phenyl, and Vi is vinyl.

Specific examples of organosiloxanes include, but are not limited to, siloxanes having the following formulae:

PhSi(OSiMe₂Vi)₃,Si(OSiMe₂Vi)₄,MeSi(OSiMe₂Vi)₃, and Ph₂Si(OSiMe₂Vi)₂,

wherein Me is methyl, Vi is vinyl, and Ph is phenyl.

The organic compound can be any organic compound containing at least one aliphatic carbon-carbon double bond per molecule, provided the compound does not prevent the organopolysiloxane (A″) from curing to form a silicone resin film. The organic compound can be an alkene, a diene, a triene, or a polyene. Further, in acyclic organic compounds, the carbon-carbon double bond(s) can be located at terminal, pendant, or at both terminal and pendant positions.

The organic compound can contain one or more functional groups other than the aliphatic carbon-carbon double bond. Examples of suitable functional groups include, but are not limited to, —O—, >C═O, —CHO, —CO₂—, —C—N, —NO₂, >C═C<, —Ce—, —F, —Cl, —Br, and —I. The suitability of a particular unsaturated organic compound for use in the free-radical curable silicone composition can be readily determined by routine experimentation.

Examples of organic compounds containing aliphatic carbon-carbon double bonds include, but are not limited to, 1,4-divinylbenzene, 1,3-hexadienylbenzene, and 1,2-diethenylcyclobutane.

The unsaturated compound can be a single unsaturated compound or a mixture comprising two or more different unsaturated compounds, each as described above. For example, the unsaturated compound can be a single organosilane, a mixture of two different organosilanes, a single organosiloxane, a mixture of two different organosiloxanes, a mixture of an organosilane and an organosiloxane, a single organic compound, a mixture of two different organic compounds, a mixture of an organosilane and an organic compound, or a mixture of an organosiloxane and an organic compound.

The free radical initiator (C″) is a compound that produces a free radical, and is utilized to initiate polymerization of the organopolysiloxane (A″). Typically, the free radical initiator (C″) produces a free radical via dissociation caused by irradiation, heat, and/or reduction by a reducing agent. The free radical initiator (C″) may be an organic peroxide. Examples of organic peroxides include, diaroyl peroxides such as dibenzoyl peroxide, di-p-chlorobenzoyl peroxide, and bis-2,4-dichlorobenzoyl peroxide; dialkyl peroxides such as di-t-butyl peroxide and 2,5-dimethyl-2,5-di-(t-butylperoxy)hexane; diaralkyl peroxides such as dicumyl peroxide; alkyl aralkyl peroxides such as t-butyl cumyl peroxide and 1,4-bis(t-butylperoxyisopropyl)benzene; and alkyl aryl peroxides such as t-butyl perbenzoate, t-butyl peracetate, and t-butyl peroctoate.

The organic peroxide (C″) can be a single peroxide or a mixture comprising two or more different organic peroxides. The concentration of the organic peroxide is typically from 0.1 to 5% (w/w), alternatively from 0.2 to 2% (w/w), based on the weight of the organopolysiloxane (A″).

The free radical-curable silicone composition may be a two-part composition where the organopolysiloxane (A″) and the free radical initiator (C″) are in separate parts.

In other embodiments, at least one of the silicone compositions comprises a ring opening reaction-curable silicone composition. In various embodiments, the ring opening reaction-curable silicone composition comprises (A′″) an organopolysiloxane having an average of at least two epoxy-substituted groups per molecule and (C′″) a curing agent. However, the ring opening reaction-curable silicone composition is not limited specifically to epoxy-functional organopolysiloxanes. Other examples of ring opening reaction-curable silicone compositions include those comprising silacyclobutane and/or benzocyclobutene.

The organopolysiloxane (A′″) may be linear, branched, cyclic, or resinous. In particular, the organopolysiloxane (A′″) may comprise any combination of M, D, T, and Q units, as with the organopolysiloxane (A′) and the organosilicon compound (B′) disclosed above.

The particular organopolysiloxane (A′″) may be selected based on desired properties of the 3D pattern or article and layers during the method. For example, it may be desirable for the patterns and/or layers to be in the form of an elastomer, a gel, a resin, etc., and selecting the components of the silicone composition allows one of skill in the art to achieve a range of desirable properties.

For example, in certain embodiments, the organopolysiloxane (A′″) comprises a silicone resin, which typically comprises T and/or Q units in combination with M and/or D units. When the organopolysiloxane (A′″) comprises a silicone resin, the silicone resin may be a DT resin, an MT resin, an MDT resin, a DTQ resin, an MTQ resin, an MDTQ resin, a DQ resin, an MQ resin, a DTQ resin, an MTQ resin, or an MDQ resin. Generally, when the hydrosilylation-curable silicone composition comprises a resin, the pattern(s) and/or layer(s) and resulting 3D pattern or article have increased rigidity.

Alternatively, in other embodiments, the organopolysiloxane (A′″) comprises repeating D units. Such organopolysiloxanes are substantially linear but may include some branching attributable to T and/or Q units. Alternatively, such organopolysiloxanes are linear. In these embodiments, the pattern(s) and/or layer(s) and resulting 3D pattern or article are elastomeric.

The epoxy-substituted groups of the organopolysiloxane (A′″) may be pendent, terminal, or in both positions. “Epoxy-substituted groups” are generally monovalent organic groups in which an oxygen atom, the epoxy substituent, is directly attached to two adjacent carbon atoms of a carbon chain or ring system. Examples of epoxy-substituted organic groups include, but are not limited to, 2,3-epoxypropyl, 3,4-epoxybutyl, 4,5-epoxypentyl, 2-glycidoxyethyl, 3-glycidoxypropyl, 4-glycidoxybutyl, 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3 epoxycylopentyl)propyl.

In a specific embodiment, the organopolysiloxane (A′″) has the general formula:

(R¹R⁵₂SiO_{1/2})_{w′″}(R⁵₂SiO_{2/2})_{x′″}(R⁵SiO_{3/2})_{y′″}(SiO_{4/2})_{z′″} (IV)

wherein each R¹ is defined above and each R⁵ is independently selected from R¹ and an epoxy-substituted group, with the proviso that at least two of R⁵ are epoxy-substituted groups, and w′″, x″, y′″, and z′″ are mole fractions such that w′″+x′″+y′″+z′″=1. As understood in the art, for linear organopolysiloxanes, subscripts y′″ and z′″ are generally 0, whereas for resins, subscripts y′″ and/or z′″>0. Various alternative embodiments are described below with reference to w′″, x′″, y′″ and z′″. In these embodiments, the subscript w′″ may have a value of from 0 to 0.9999, alternatively from 0 to 0.999, alternatively from 0 to 0.99, alternatively from 0 to 0.9, alternatively from 0.9 to 0.999, alternatively from 0.9 to 0.999, alternatively from 0.8 to 0.99, alternatively from 0.6 to 0.99, The subscript x′″ typically has a value of from 0 to 0.9, alternatively from 0 to 0.45, alternatively from 0 to 0.25. The subscript y′″ typically has a value of from 0 to 0.99, alternatively from 0.25 to 0.8, alternatively from 0.5 to 0.8. The subscript z′″ typically has a value of from 0 to 0.99, alternatively from 0 to 0.85, alternatively from 0.85 to 0.95, alternatively from 0.6 to 0.85, alternatively from 0.4 to 0.65, alternatively from 0.2 to 0.5, alternatively from 0.1 to 0.45, alternatively from 0 to 0.25, alternatively from 0 to 0.15.

The curing agent (C′″) can be any curing agent suitable for curing the organopolysiloxane (A′″). Examples of curing agents (C′″) suitable for that purpose include phenolic compounds, carboxylic acid compounds, acid anhydrides, amine compounds, compounds containing alkoxy groups, compounds containing hydroxyl groups, or mixtures thereof or partial reaction products thereof. More specifically, examples of curing agents (C′″) include tertiary amine compounds, such as imidazole; quaternary amine compounds; phosphorus compounds, such as phosphine; aluminum compounds, such as organic aluminum compounds; and zirconium compounds, such as organic zirconium compounds. Furthermore, either a curing agent or curing catalyst or a combination of a curing agent and a curing catalyst can be used as the curing agent (C′″). The curing agent (C′″) can also be a photoacid or photoacid generating compound.

The ratio of the curing agent (C′″) to the organopolysiloxane (A′″) is not limited. In certain embodiments, this ratio is from 0.1-500 parts by weight of the curing agent (C′″) per 100 parts by weight of the organopolysiloxane (A′″).

In other embodiments, at least one of the silicone compositions comprises a thiol-ene curable silicone composition. In these embodiments, the thiol-ene curable silicone composition typically comprises: (A″″) an organopolysiloxane having an average of at least two silicon-bonded alkenyl groups or silicon-bonded mercapto-alkyl groups per molecule; (B″″) an organosilicon compound having an average of at least two silicon-bonded mercapto-alkyl groups or silicon-bonded alkenyl groups per molecule capable of reacting with the silicon-bonded alkenyl groups or silicon-bonded mercapto-alkyl groups in the organopolysiloxane (A″″); (C″″) a catalyst; and (D″″) an optional organic compound containing two or more mercapto groups. When the organopolysiloxane (A″″) includes silicon-bonded alkenyl groups, the organosilicon compound (B″″) and/or the organic compound (D″″) include at least two mercapto groups per molecule bonded to the silicon and/or in the organic compound, and when the organopolysiloxane (A″″) includes silicon-bonded mercapto groups, the organosilicon compound (B″″) includes at least two silicon-bonded alkenyl groups per molecule. The organosilicon compound (B″″) and/or the organic compound (D″″) may be referred to as a cross-linker or cross-linking agent.

The catalyst (C″″) can be any catalyst suitable for catalyzing a reaction between the organopolysiloxane (A″″) and the organosilicon compound (B″″) and/or the organic compound (D″″). Typically, the catalyst (C″″) is selected from: i) a free radical catalyst; ii) a nucleophilic reagent; and iii) a combination of i) and ii). Suitable free radical catalysts for use as the catalyst (C″″) include photo-activated free radical catalysts, heat-activated free radical catalysts, room temperature free radical catalysts such as redox catalysts and alkylborane catalysts, and combinations thereof. Suitable nucleophilic reagents for use as the catalyst (C″″) include amines, phosphines, and combinations thereof.

In still other embodiments, at least one of the silicone compositions comprises a silicon hydride-silanol reaction curable silicone composition. In these embodiments, the silicon hydride-silanol reaction curable silicone composition typically comprises: (A′″″) an organopolysiloxane having an average of at least two silicon-bonded hydrogen atoms or at least two silicone bonded hydroxyl groups per molecule; (B′″″) an organosilicon compound having an average of at least two silicon-bonded hydroxyl groups or at least two silicon bonded hydrogen atoms per molecule capable of reacting with the silicon-bonded hydrogen atoms or silicon-bonded hydroxyl groups in the organopolysiloxane (A′″″); (C′″″) a catalyst; and (D′″″) an optional active hydrogen containing compound. When the organopolysiloxane (A′″″) includes silicon-bonded hydrogen atoms, the organosilicon compound (B′″″) and/or the organic compound (D′″″) include at least two hydroxyl groups per molecule bonded to the silicon and/or in the active hydrogen containing compound, and when the organopolysiloxane (A′″″) includes silicon-bonded hydroxyl groups, the organosilicon compound (B′″″) includes at least two silicon-bonded hydrogen atoms per molecule. The organosilicon compound (B′″″) and/or the organic compound (D′″″) may be referred to as a cross-linker or cross-linking agent.

Typically, the catalyst (C′″″) is selected from: i) a Group X metal-containing catalyst such as platinum; ii) a base such as metal hydroxide, amine, or phosphine; and iii) combinations thereof.

Solidification conditions for such silicon hydride-silanol condensation-curable silicone compositions may vary. Typically, such compositions are mixed as a two-part system and subsequently cured under ambient conditions. However, heat may also be utilized during solidification.

Any of the silicone compositions may optionally and independently further comprise additional ingredients or components, especially if the ingredient or component does not prevent the organosiloxane of the composition from curing. Examples of additional ingredients include, but are not limited to, fillers; inhibitors; adhesion promoters; dyes; pigments; anti-oxidants; carrier vehicles; heat stabilizers; flame retardants; thixotroping agents; flow control additives; fillers, including extending and reinforcing fillers; and cross-linking agents. In various embodiments, the composition further comprises ceramic powder. The amount of ceramic powder can vary and may depend on the 3D printing process being utilized.

One or more of the additives can be present as any suitable wt. % of the particular silicone composition, such as about 0.1 wt. % to about 15 wt. %, about 0.5 wt. % to about 5 wt. %, or about 0.1 wt. % or less, about 1 wt. %, 2, 3, 4, 5, 6, 7, 8, 9, 10, 11, 12, 13, 14, or about 15 wt. % or more of the silicone composition.

In certain embodiments, the silicone compositions are shear thinning. Compositions with shear thinning properties may be referred to as psuedoplastics. As understood in the art, compositions with shear thinning properties are characterized by having a viscosity which decreases upon an increased rate of shear strain. Said differently, viscosity and shear strain are inversely proportional for shear thinning compositions. When the silicone compositions are shear thinning, the silicone compositions are particularly well suited for printing, especially when a nozzle or other dispense mechanism is utilized. A specific example of a shear thinning silicone composition is XIAMETER® 9200 LSR, commercially available from Dow Silicones Corporation of Midland, Mich.

In certain embodiments, at least one of the compositions, e.g. the substrate composition, the first composition, the second composition, and/or any subsequent or additional compositions, comprises the metal. The metal may be any of metal or alloy, and may be a liquid or slurry. Typically, a low-melting metal is used such that the at least one composition comprising the metal and/or the metal itself can be melted in an extruder and printed and/or deposited accordingly. In some embodiments, porous sections comprising the metal are formed during the printing process. Alternatively, sections comprising the metal which are not porous are formed during the printing process and may be incorporated as a section in the 3D pattern or article to add functionality (e.g. structural support, section separation, etc.). When the metal is a liquid, an appropriate solidification condition and/or mechanism is utilized. Such solidification conditions include sufficient cooling and forming a solid alloy with another material already presented on the substrate the liquid metal is being deposited onto. In some embodiments, the metal is a slurry of metal particles in a carrier such as water or a non-oxidizing solvent. The slurry can be printed into a porous section by itself, or as a nonporous section of an otherwise porous body. The printed section formed from slurry can be further processed, such as via laser melting, etching, and/or sintering.

In certain embodiments, at least one of the compositions, e.g. the substrate composition, the first composition, the second composition, and/or any subsequent or additional compositions, comprises the slurry. In one embodiment, the slurry is a ceramic slurry. The ceramic slurry may be carried by water, and may be combined with one or more binders, such as one of the resins described above. Typically, the ceramic slurry can be dried/solidified via evaporation of the carrier (e.g. water) and/or drying. The dried/solidified ceramic slurry can be further processed or consolidated by heating, such as via convection, heat conduction, or radiation. Ceramics that may be used to form the ceramic slurry include oxides of various metals, carbides, nitrides, borides, silicides, and combinations and/or modifications thereof. In some embodiments, as mentioned above, the slurry is a metal slurry. In these or other embodiments, the slurry comprises, alternatively is a resin slurry. The resin slurry is typically a solution or dispersion of a resin in water or an organic solvent. The resin slurry may comprise any suitable resin, such as one of the resins described above, and typically comprises a viscosity suitable for printing at ambient or elevated temperatures.

Any of the compositions may optionally and independently further comprise additional ingredients or components, especially if the ingredient or component does not prevent any particular component of the composition from curing. Examples of additional ingredients include: inhibitors; adhesion promoters; dyes; pigments; anti-oxidants; carrier vehicles; heat stabilizers; flame retardants; thixotroping agents; flow control additives; fillers, including extending and reinforcing fillers; and cross-linking agents. In various embodiments, the composition further comprises ceramic powder. The amount of ceramic powder can vary and may depend on the 3D printing process being utilized.

In specific embodiments, the first composition further comprises a filler and the first composition is further defined as a paste. In other embodiments, the first composition further comprises a filler and is not a paste. The filler may be an extending and/or reinforcing filler. Non-limiting examples of fillers include those formed with, comprising, or consisting of quartz and/or crushed quartz, aluminum oxide, magnesium oxide, silica (e.g. fumed, ground, precipitated), hydrated magnesium silicate, magnesium carbonate, dolomite, silicone resin, wollastonite, soapstone, kaolinite, kaolin, mica muscovite, phlogopite, halloysite (hydrated alumina silicate), aluminum silicate, sodium aluminosilicate, glass (fiber, beads or particles, including recycled glass, e.g. from wind turbines or other sources), clay, magnetite, hematite, calcium carbonate such as precipitated, fumed, and/or ground calcium carbonate, calcium sulfate, barium sulfate, calcium metasilicate, zinc oxide, talc, diatomaceous earth, iron oxide, clays, mica, chalk, titanium dioxide (titania), zirconia, sand, carbon black, graphite, anthracite, coal, lignite, charcoal, activated carbon, non-functional silicone resin, alumina, metal powders, magnesium oxide, magnesium hydroxide, magnesium oxysulfate fiber, aluminum trihydrate, aluminum oxyhydrate, carbon fibers, poly-aramids, nylon fibers, mineral fillers or pigments (e.g. titanium dioxide), non-hydrated, partially hydrated, or hydrated fluorides, chlorides, bromides, iodides, chromates, carbonates, hydroxides, phosphates, hydrogen phosphates, nitrates, oxides, and sulfates of sodium, potassium, magnesium, calcium, and barium; zinc oxide, antimony pentoxide, antimony trioxide, beryllium oxide, chromium oxide, lithopone, boric acid or a borate salt such as zinc borate, barium metaborate or aluminum borate, mixed metal oxides such as vermiculite, bentonite, pumice, perlite, fly ash, clay, and silica gel; rice hull ash, ceramic, zeolites, and combinations thereof.

Each of the additives can be present at any suitable wt. % of the particular composition, such as about 0.1 wt. % to about 15 wt. %, about 0.5 wt. % to about 5 wt. %, or about 0.1 wt. % or less, about 1 wt. %, 2, 3, 4, 5, 6, 7, 8, 9, 10, 11, 12, 13, 14, or about 15 wt. % or more of the particular composition.

In certain embodiments, the compositions are shear thinning. Compositions with shear thinning properties may be referred to as psuedoplastics. As understood in the art, compositions with shear thinning properties are characterized by having a viscosity which decreases upon an increased rate of shear strain. Said differently, viscosity and shear strain are inversely proportional for shear thinning compositions. When the compositions are shear thinning, the compositions are particularly well suited for printing, especially when a nozzle or other dispense mechanism is utilized. A specific example of a shear-thinning composition comprising a silicone composition is XIAMETER® 9200 LSR, commercially available from Dow Silicones Corporation of Midland, Mich.

Any of the compositions described above may be a single part or a multi-part composition, as described above with reference to certain silicone compositions. Certain compositions are highly reactive such that multi-part compositions prevent premature mixing and curing of the components.

The multi-part composition may be, for example, a two-part system, a three-part system, etc. contingent on the selection of the composition and the components thereof. Any component of the composition may be separate from and individually controlled with respect to the remaining components.

In certain embodiments, when the compositions are multi-part compositions, the separate parts of the multi-part composition may be mixed in a dispense printing nozzle, e.g. a dual dispense printing nozzle, prior to and/or during printing. Alternatively, the separate parts may be combined immediately prior to printing. Alternatively still, the separate parts may be combined after exiting the nozzle, e.g. by crossing printing streams or by mixing the separate parts as the patterns and/or layers are formed.

The compositions can be of various viscosities, such as any of the dynamic viscosities described above in relation to the first composition. In certain embodiments, the viscosity of the composition is further defined as a kinematic viscosity, and is less than 500, less than 250, or less than 100, centistokes (cSt) at 25° C., where 1 cSt=1 mm²·s⁻¹=10-6 m²·s⁻¹. In some embodiments, the composition comprises a kinematic viscosity of from 1 to 1,000,000, from 1 to 100,000, or from 1 to 10,000 cSt at 25° C. Viscosity of each composition can be changed by altering the amounts and/or molecular weight of one or more components thereof. Viscosity may be adjusted to match components of the nozzle or apparatus, particularly any nozzle or dispensing mechanism, to control heat, speed or other parameters associated with printing. As readily understood in the art, dynamic and/or kinematic viscosity may be measured in accordance with various methods and techniques, such as those set forth in ASTM D-445 (2011), titled “Standard Test Method for Kinematic Viscosity of Transparent and Opaque Liquids (and Calculation of Dynamic Viscosity);” ASTM D-7483 (2017), titled “Standard Test Method for Determination of Dynamic Viscosity and Derived Kinematic Viscosity of Liquids by Oscillating Piston Viscometer;” ASTM D-7945 (2016), titled “Standard Test Method for Determination of Dynamic Viscosity and Derived Kinematic Viscosity of Liquids by Constant Pressure Viscometer;” and/or ASTM D7042 (2016), titled “Standard Test Method for Dynamic Viscosity and Density of Liquids by Stabinger Viscometer (and the Calculation of Kinematic Viscosity);” and the like, as well as modifications and/or combinations thereof.

As will be appreciated from the disclosure herein, the compositions may be in any form suitable for printing and, subsequently, for solidification after printing. Accordingly, each composition utilized may independently be in a liquid, solid, or semi-solid form. For example, each composition may be utilized as a liquid suitable for forming streams and/or droplets, a powder, and/or a heat-meltable solid, depending on the particular composition and printing conditions selected and as described above.

As described above with respect to the first composition in particular, the elastic modulus of suitable examples of the composition is varied, and may change over time, e.g. due to curing, crosslinking, and/or hardening of the composition, including during the method. Typically, the elastic modulus of the composition is in the range of from 0.01 to 5000 MPa, such as from 0.1 to 150, from 0.1 to 125, from 0.2 to 100, from 0.2 to 90, from 0.2 to 80, from 0.3 to 80, from 0.3 to 70, from 0.3 to 60, from 0.3 to 50, from 0.3 to 45, from 0.4 to 40, or from 0.5 to 10 MPa. These ranges may apply to the elastic modulus of the composition at any time, such as before printing, during printing, and/or after printing. Moreover, more than one of such ranges may apply to the composition, e.g. when the elastic modulus of the composition changes over time (e.g. during and/or after printing). In certain embodiments, the composition has an elastic modulus of less than 120, alternatively less than 110, alternatively less than 100, alternatively less than 90, alternatively less than 80, alternatively less than 70, alternatively less than 60, alternatively less than 50, alternatively less than 40, alternatively less than 30 MPa during printing. As readily understood in the art, elastic modulus may be measured in accordance with various methods and techniques, such as those set forth in ASTM D638 (2014), titled “Standard Test Method for Tensile Properties of Plastics,” and the like, as well as via modifications and/or combinations thereof.

When the solidification condition comprising heating, exposure to the solidification condition typically comprises heating the pattern(s) and/or layer(s) at an elevated temperature for a period of time. The elevated temperature and the period of time may vary based on numerous factors, including the selection of the particular silicone composition, a desired cross-link density of the at least partially solidified layer, dimensions of the pattern(s) and/or layer(s), etc. In certain embodiments, the elevated temperature is from above room temperature to 500, alternatively from 30 to 450, alternatively from 30 to 350, alternatively from 30 to 300, alternatively from 30 to 250, alternatively from 40 to 200, alternatively from 50 to 150, ° C. In these or other embodiments, the period of time is from 0.001 to 600, alternatively from 0.04 to 60, alternatively from 0.1 to 10, alternatively from 0.1 to 5, alternatively from 0.2 to 2, minutes.

Any source of heat may be utilized for exposing the pattern(s) and/or layer(s) to heat. For example, the source of heat may be a convection oven, rapid thermal processing, a hot bath, a hot plate, or radiant heat. Further, if desired, a heat mask or other similar device may be utilized for selective curing of the pattern(s) and/or layer(s), as introduced above.

In certain embodiments, heating is selected from (i) conductive heating via a substrate on which the pattern or layer is printed; (ii) heating the silicone composition via the 3D printer or a component thereof; (iii) infrared heating; (iv) radio frequency or micro-wave heating; (v) a heating bath with a heat transfer fluid; (vi) heating from an exothermic reaction of the silicone composition; (vii) magnetic heating; (viii) oscillating electric field heating; and (ix) combinations thereof. When the method includes more than one heating step, e.g. in connection with each individual layer, each heating step is independently selected.

Such heating techniques are known in the art. For example, the heat transfer fluid is generally an inert fluid, e.g. water, which may surround and contact the pattern or layer as the silicone composition is printed, thus initiating at least partial curing thereof. With respect to (ii) heating the silicone composition via the 3D printer or a component thereof, any portion of the silicone composition may be heated and combined with the remaining portion, or the silicone composition may be heated in its entirety. For example, a portion (e.g. one component) of the silicone composition may be heated, and, once combined with the remaining portion, the silicone composition initiates curing. The combination of the heated portion and remaining portion may be before, during, and/or after the step of printing the silicone composition. The components may be separately printed.

Alternatively or in addition, the solidification condition may be exposure to irradiation.

The energy source independently utilized for the irradiation may emit various wavelengths across the electromagnetic spectrum. In various embodiments, the energy source emits at least one of ultraviolet (UV) radiation, microwave radiation, radiofrequency radiation, infrared (IR) radiation, visible light, X-rays, gamma rays, oscillating electric field, or electron beams (e-beam). One or more energy sources may be utilized.

In certain embodiments, the energy source emits at least UV radiation. In physics, UV radiation is traditionally divided into four regions: near (400-300 nm), middle (300-200 nm), far (200-100 nm), and extreme (below 100 nm). In biology, three conventional divisions have been observed for UV radiation: near (400-315 nm); actinic (315-200 nm); and vacuum (less than 200 nm). In specific embodiments, the energy source emits UV radiation, alternatively actinic radiation. The terms of UVA, UVB, and UVC are also common in industry to describe the different wavelength ranges of UV radiation.

In certain embodiments, the radiation utilized to cure the pattern(s) and/or layer(s) may have wavelengths outside of the UV range. For example, visible light having a wavelength of from 400 nm to 800 nm can be used. As another example, IR radiation having a wavelength beyond 800 nm can be used.

In other embodiments, e-beam can be utilized to cure the pattern(s) and/or layer(s). In these embodiments, the accelerating voltage can be from about 0.1 to about 10 MeV, the vacuum can be from about 10 to about 10⁻³ Pa, the electron current can be from about 0.0001 to about 1 ampere, and the power can vary from about 0.1 watt to about 1 kilowatt. The dose is typically from about 100 micro-coulomb/cm² to about 100 coulomb/cm², alternatively from about 1 to about 10 coulombs/cm². Depending on the voltage, the time of exposure is typically from about 10 seconds to 1 hour; however, shorter or longer exposure times may also be utilized.

The 3D pattern or article formed in accordance to the method is not limited, and may be any 3D pattern or article formable using an AM process suitable for practicing the method of this disclosure. Typically, the 3D pattern or article comprises flexible components and/or thin walls, such as those formed using the compositions of this disclosure. For example, in certain embodiments the 3D pattern or article is a pneumatic actuator that is may bend, move, or otherwise flex in response to a pneumatic force (e.g. air pressure) being applied thereto. In these or other embodiments, the 3D pattern or article is a biological (e.g. medical and/or dental) device. In such embodiments, the 3D pattern or article may advantageously be formed using the flexible silicone compositions of this disclosure, e.g. due to their high biocompatibility. Example of such medical devices include prostheses, tubing (e.g. feeding tubes), drains, catheters, implants (e.g. long-term and/or short term), seals, gaskets, syringe pistons, dental guards, etc.

The following examples, illustrating methods and 3D patterns or articles formed thereby, are intended to illustrate and not to limit the invention.

### EXAMPLES

### Examples 1 and 2

The material utilized in the Examples is a two-part silicone composition, with part A comprising 45 wt. % ground CaCO₃ and 55 wt. % SiOH terminated PDMS having a viscosity at 25° C. of ˜50,000 cps, and part B comprising 54.9 wt. % of ground CaCO₃, 45 wt. % of a trimethoxysilyl-terminated PDMS having a viscosity at 25° C. ˜55,000 cps, and 0.1 wt. % of dimethyl tin dineodecanoate. When the two parts were mixed, the silicone composition had a k of 650 Pa·sⁿ, n of 0.6, p of 1295 kg/m³, and a of 880 m/s.

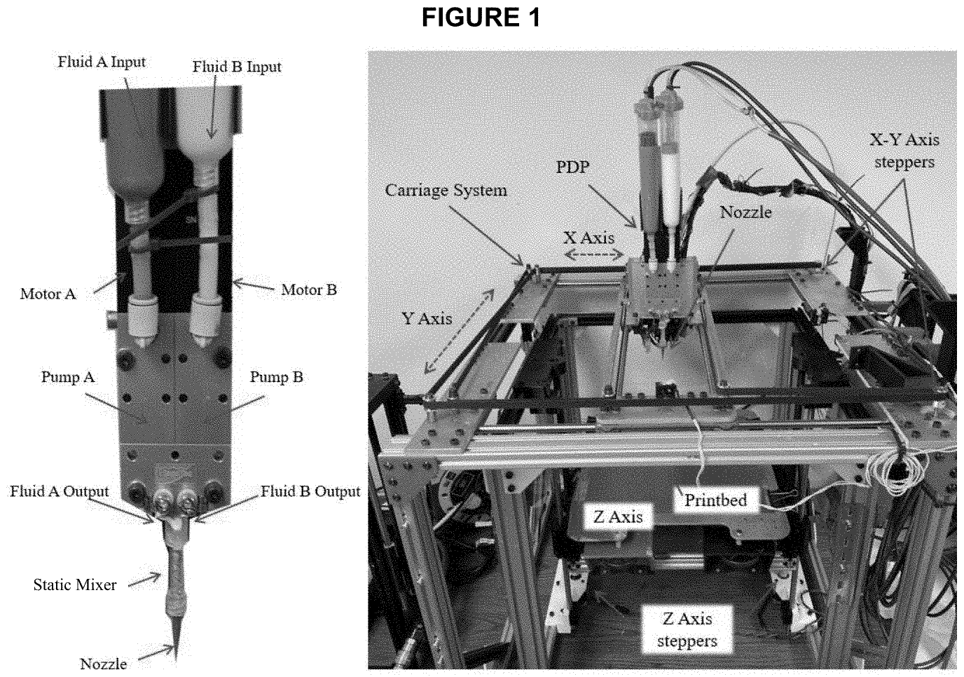

The Examples utilized a direct ink write (DIW), i.e. material extrusion printing, machine, as shown in FIG. 1, which had a positive displacement pump (PDP) and is based on a CoreXY design. The PDP, as shown in FIG. 1, is a dual progressive cavity pump (Vipro-Head 3/3, Viscotec, Toeging am Inn, Germany) that can dispense two high viscosity fluids precisely with rotors forcing fluid through small cavities in a stator. This fluid dispensing method has no pulsing, and the amount of fluid dispensed is directly controlled by the motor rotation. The CoreXY gantry, also shown in FIG. 1, uses two stepper motors and belts to control the X and Y positions of the extrusion nozzle on the PDP. The Z position of the extrusion nozzle is controlled by a movable print bed driven by a pair of lead screws attached to stepper motors. The control board is a RAMBo 1.4 (Ultimachine, South Pittsburgh, Tenn., USA). An open-source firmware (Marlin Firmware v1.1.9) that uses a trapezoidal motion planner controls the DIW system by taking points in the form of G-code and translating them into velocities for the motors.

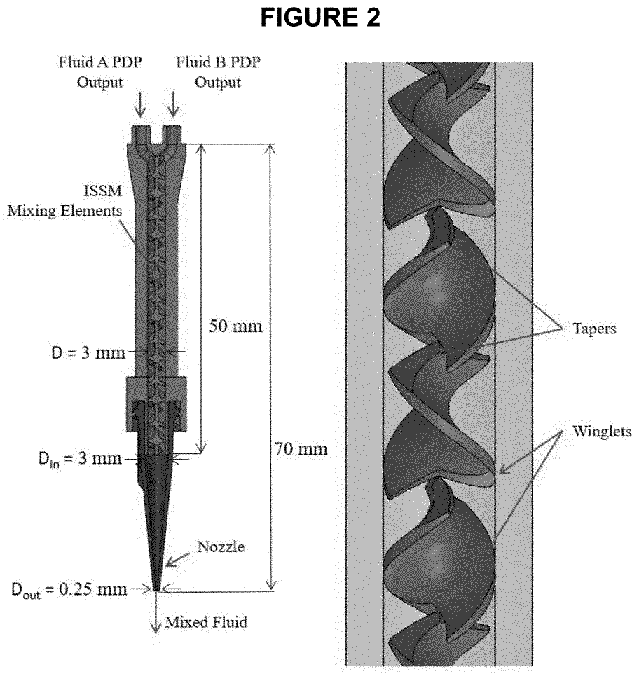

A static mixer (i.e., an impeller spiral static mixer (ISSM)) performs the in-situ mixing of the two parts of the two-part silicone composition dispensed by the PDP. The static mixer attached to the PDP is custom designed and 3D-printed to reduce the pressure drop along its length, and is shown in FIG. 2. The 3D-printed static mixer has a length of 50 mm and an inner diameter of 3 mm. A tapered dispensing nozzle is attached to the static mixer end has a length of 20 mm, an inlet inner diameter of 3 mm, and an outlet inner diameter of 0.25 mm. The boundary conditions for the PDP in the examples are constant pressure outlet and a volumetrically controlled inlet.

The constant pressure outlet boundary condition assumes that the pressure of the outlet, P_{i,outlet}, is held constant at gauge pressure. The volumetric flow controlled inlet boundary condition assumes that the flowrate of the inlet, Q_{i,inlet}, can be varied according to an arbitrary time function.

Open-source one-dimensional water hammer code was adopted to simulate the transient flow in the DIW machine. The code uses the characteristic method (CM) to solve the transient fluid problem and was modified to allow for the boundary conditions needed to simulate the DIW. The differential equations associated with the CM are known in the art and described in, for example, M. H. Chaudhry, Applied Hydraulic Transients, 3rd ed., Springer, 2014, which is incorproated herein by reference.

CM is evaluated by modeling the step response of the DIW machine in a two-step response test. The two-step response can validate the CM's ability to predict DIW characteristics using pressure and volumetric output data measured during testing.

The two-step response test includes two step changes to the input fluid flowrate performed on both a pipe and an ISSM. Starting with zero input volumetric flow, the input volumetric flowrate is stepped to a higher flowrate, held for a period of time, and then stepped down to no flow again.

The pressure and volumetric flowrate during the experimental two-step response tests were measured to verify the CM modeling results.

In the Examples, the input fluid flowrate of the two-part silicone composition was initiated at 0 mL/min and stepped to 1 mL/min. Fluid flow was maintained for 3.2 s and then step-changed back to 0 mL/min. The test was allowed to run for a further 1.7 s for a total test time of 5 s.

The pipe and ISSM used for the experimental two-step response tests had the same dimensions as in the CM simulation. Two piezoresistive pressure sensors (Model 24PCGFH6G, Honeywell Charlotte, N.C., USA) were placed at the fluid inlet and near the fluid outlet of the pipe or ISSM. A clamp-on ultrasonic Doppler volumetric flow sensor (Model FD-XS8, Keyence, Osaka, Osaka, Japan) measured the fluid flowrate. The pressure sensors were placed at the pipe and ISSM and 150 mm from the inlet. An op-amp circuit amplifies the signal from the pressure sensors with a gain of 10. The amplified pressure sensor signal and analog volumetric flow sensor signal were read by an Arduino microprocessor (Arduino Mega 2560 Rev3) at a 500 Hz sampling rate. The pressure sensors were calibrated against a pressure gauge (Model DPGA-07, Dwyer Instruments Michigan City, Ind.) using a custom pressure manifold. The volumetric flow sensor was zeroed against a pipe or ISSM filled with fluid but had no flow before every test to prevent signal drift. The pressure drop is defined as the difference in pressure from Pressure Sensor #1 to Pressure Sensor #2.

The experimental two-step response test was repeated six times for both the pipe and the ISSM for a total of 12 tests. Noise from the volumetric flow sensor was filtered using a robust loess filter with a smoothing window of 0.1 s in Matlab™ (R2019B). Pressure sensor data was not filtered.

FIG. 3 shows the desired characteristics of the pattern or layer to be formed in Examples 1 and 2, respectively. In particular, in Example 1, the pattern or layer includes a 90-degree turn, whereas in Example 2, the pattern or layer includes a U-turn. The 90-degree turn is denoted by points A, B, and C, with |AB|=|BC|=l and ∠{A, B, C}=90°. The U-turn is denoted by points A, B, C, and D with |AB|=|CD|=l, |BC|=w, and A̅B̅∥C̅D̅. Point A is the beginning of the nozzle deceleration, point B is the point of minimum nozzle velocity and starting of acceleration, and point C is the end of the nozzle acceleration. At point B, there may be excess fluid deposited which causes corner swell.

The target print dimensions for the Examples are w=0.3 mm, l=5 mm, and h=0.2 mm. For all the individual geometric feature tests, the DIW system had |v_{c}|=25 mm/s, |a_{c}|=500 mm/s², J=2 mm/s, |aₑ|=500 mm/s², and Jₑ=² mm/s. The inventive method including a corrective signal is applied to the respective turns of Examples 1 and 2. The 90-degree turn and U-turn are printed using the DIW system five times without the inventive method including a corrective signal and five times with the inventive method including a corrective signal. In total, 20 tests were conducted.

After printing the 90-degree turn of Example 1, a picture of the actual characteristics of the trial pattern or trial layer were taken by a digital microscope camera (UWT500X020M, AmScope Irvine Calif.) placed directly over the point B. The microscope camera was calibrated with a caliper digital caliper (8000-F6, Products Engineering Corporation, Torrance, Calif.).

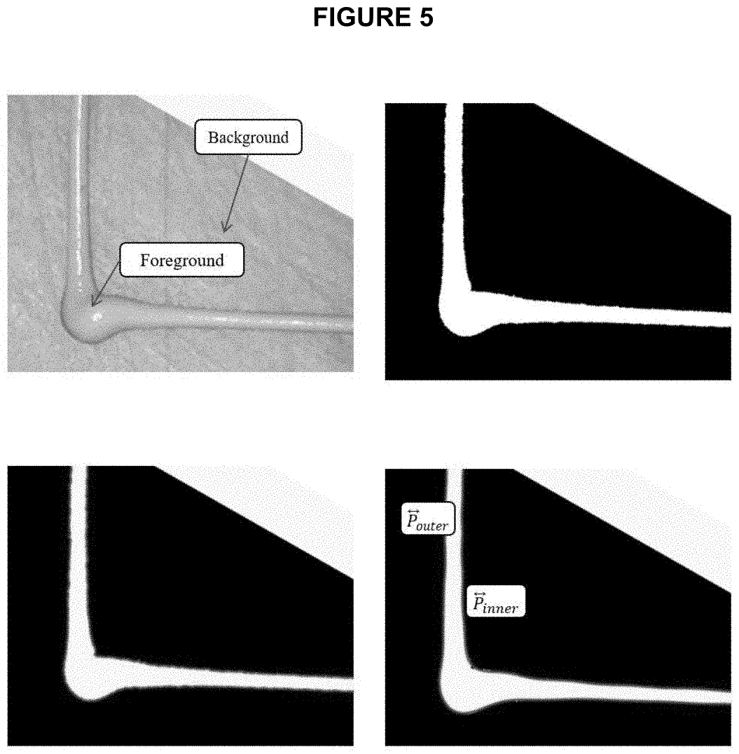

The image from the microscope camera, shown as FIG. 5, was processed in Matlab™ (R2019B) to measure the print profile, tool path, and corner swell of the PDP DIW extrusion. The print profile consists of two lines, the outer print profile, [symbol] , and the inner print profile, [symbol] . The color image is turned into a binary image (im2bw) using the background color as the threshold value, and image boundary detection (bwboundaries) the boundaries of the extrusion are found. The resulting boundary lines are smoothed with a 61 st order Savitzky-Golay filter (sgolayfilt) using a frame length of 10 mm to define [symbol] and [symbol] without affecting the shape of the lines significantly.

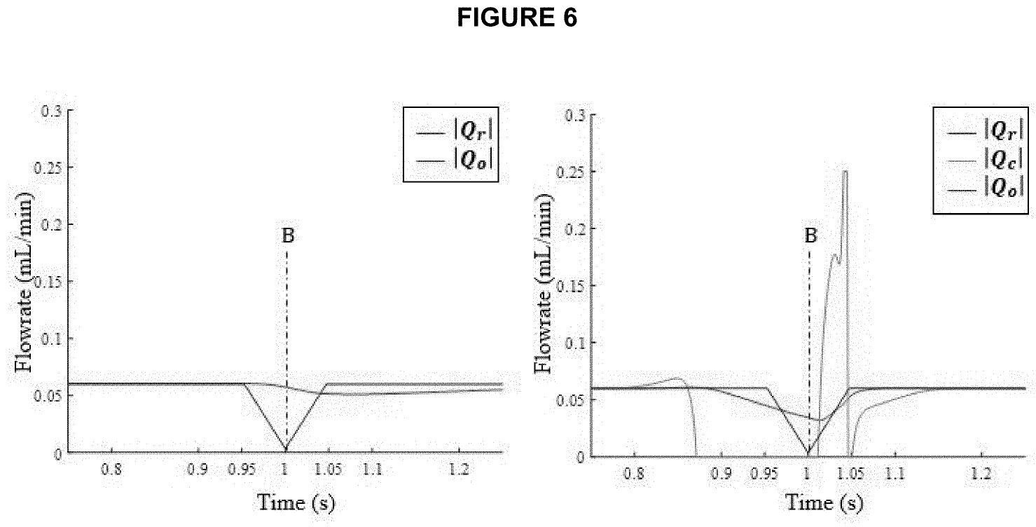

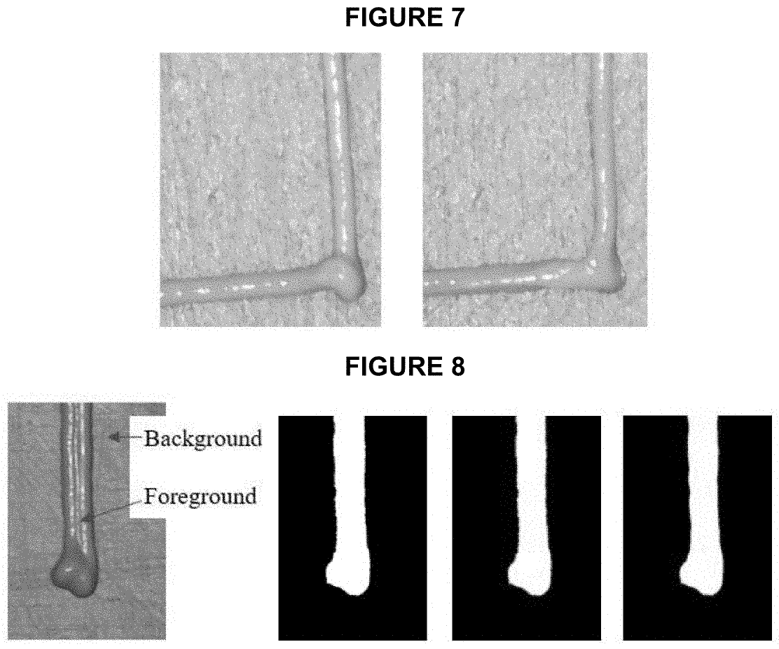

FIG. 6 shows the flowrate of the first composition to form the 90-degree turn of Example 1 during conventional 3D printing without use of the inventive method (left side of FIG. 6) versus the flowrate of the first composition as modified to minimize dimensional differences between the desired characteristics of the pattern or layer and predicted characteristics of the pattern or layer based on computational simulation modeling (right side of FIG. 6). FIG. 7 shows the resulting improvement in a 90-degree turn based on the inventive method, with the left side of FIG. 7 showing the bulge in the 90-degree turn associated with conventional printing, and the reduction of the bulge based on the inventive method in the right side of FIG. 7.

Table 1 below shows the bulge diameter for the 90-degree turn of Example 1 during conventional 3D printing both without use of the inventive method and with the inventive method based on computational simulation modeling.

TABLE 1
Improvements in deviations of diameter in printing
a 90-degree turn via the inventive method

| Conventional Printing | | | Inventive Printing | | |
|---|---|---|---|---|---|
| Sample | Diameter (mm) | % Error | Sample | Diameter (mm) | % Error |
| 1 | 0.61 | 69.4 | 1 | 0.45 | 25.0 |
| 2 | 0.63 | 75.0 | 2 | 0.48 | 33.3 |
| 3 | 0.62 | 72.2 | 3 | 0.46 | 27.8 |
| 4 | 0.68 | 88.9 | 4 | 0.56 | 55.6 |
| 5 | 0.63 | 75.0 | 5 | 0.50 | 38.9 |
| Average | 0.63 | 76.1 | Average | 0.49 | 36.1 |

After printing the U-degree turn of Example 2, a picture of the actual characteristics of the trial pattern or trial layer were taken by a digital microscope camera (UWT500X020M, AmScope Irvine Calif.) placed directly over the point B. The microscope camera was calibrated with a caliper digital caliper (8000-F6, Products Engineering Corporation, Torrance, Calif.). Instead of diameter, this width of the bulge was used to quantify the quality of the U-turn print because the shape of the deposition for the U-turn does not fit a circle well. The U-turn image was first converted into a binary (im2bw) using the background of the image as the threshold value, as shown in FIG. 8. Second, the image boundary was found using the edge detection algorithm (bwboundaries). The print boundary was smoothed with a 61st order Savitzky-Golay filter (sgolayfilt) with a frame length of 10 mm to find the edges of the print.

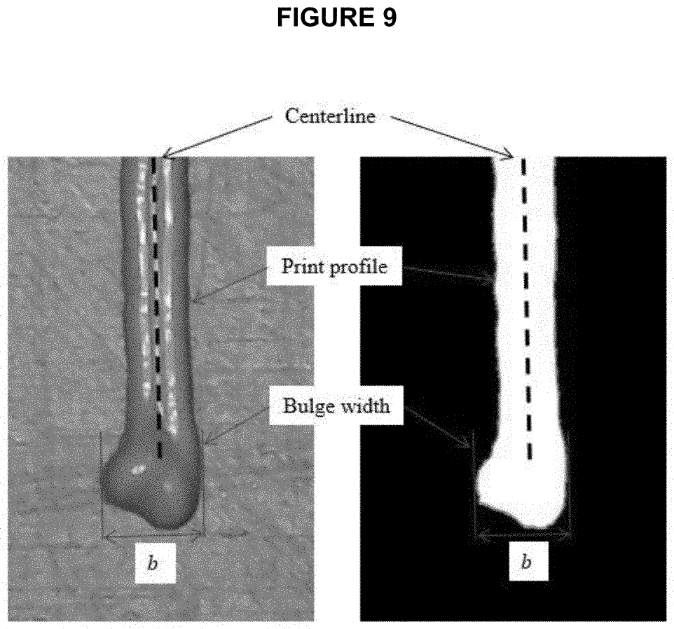

As shown in FIG. 9, the edges of the print profile are averaged to estimate the U-turn's centerline. Two lines are created that are parallel to the centerline and tangent to the bulge on the left and right, respectively. The distance between these parallel lines is the bulge's width, which is marked as b, and compared between tests with and without inventive method including a corrective signal.

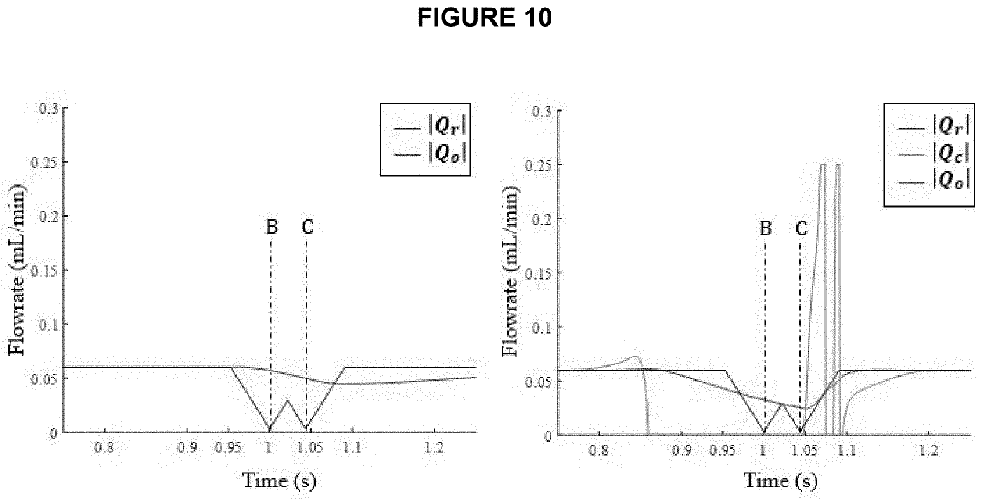

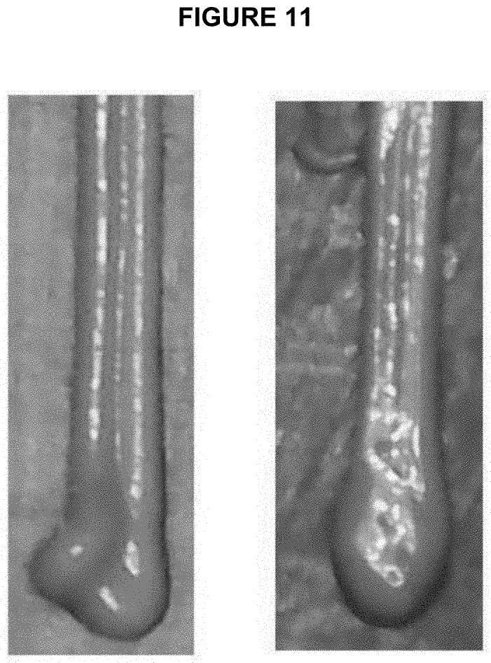

FIG. 10 shows the flowrate of the first composition to form the U-turn of Example 2 during conventional 3D printing without use of the inventive method (left side of FIG. 10) versus the flowrate of the first composition as modified to minimize dimensional differences between the desired characteristics of the pattern or layer and predicted characteristics of the pattern or layer based on computational simulation modeling (right side of FIG. 10). FIG. 11 shows the resulting improvement in a U-turn based on the inventive method, with the left side of FIG. 11 showing the bulge in the U-turn associated with conventional printing, and the reduction of the bulge based on the inventive method in the right side of FIG. 11.

Table 2 below shows the bulge diameter for the U-turn of Example 2 during conventional 3D printing both without use of the inventive method and with the inventive method based on computational simulation modeling.

TABLE 2
Improvements in deviations of diameter in
printing a U-turn via the inventive method

| Conventional Printing | | | Inventive Printing | | |
|---|---|---|---|---|---|
| Sample | Width (mm) | % Error | Sample | Width (mm) | % Error |
| 1 | 1.03 | 71.6 | 1 | 0.86 | 43.3 |
| 2 | 1.01 | 68.3 | 2 | 0.79 | 31.7 |
| 3 | 0.97 | 61.6 | 3 | 0.79 | 31.7 |
| 4 | 0.98 | 63.3 | 4 | 0.82 | 36.7 |
| 5 | 0.90 | 50.0 | 5 | 0.86 | 43.3 |
| Average | 0.98 | 63.0 | Average | 0.82 | 37.3 |

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

| Symbol | Meaning |
|---|---|
| A | Cross sectional area |
| a | Acoustic wave speed |
| a_{c} | Cartesian acceleration vector |
| aₑ | Extrusion acceleration vector |
| a_{g} | Gompertz asymptote |
| b | Width of bulge in U-turn |
| b_{g} | Gompertz displacement |
| Cₓ | Corner swell X deviation |
| C_{y} | Corner swell Y deviation |
| CoVr | Coefficient of variation |
| c_{g} | Gompertz growth rate |
| D | Pipe diameter |
| Dₑₓₚ | Experimental corner swell |
| Dₕ | Hydraulic diameter |
| Dᵢₙ | Inlet diameter |
| Dₒᵤₜ | Outlet diameter |
| D_{swell} | Corner swell diameter |
| Dₜₐₚₑᵣ | Taper diameter |
| E | Extrusion axis |
| E_{y} | Young's modulus |
| e | Pipe wall thickness |
| F | Frictional term |
| f | Darcy friction factor |
| f_{mod} | Modified Darcy friction factor |
| G | iLQR error factor matrix |
| G′ | Shear rate |
| g | Gravity |
| h | Layer height |
| I | Identify matrix |
| J | Jerk in the Cartesian coordinate |
| Jₑ | Jerk in the extrusion coordinate |
| K | Bulk modulus |
| K_{G} | Shear parameter |
| Kᵢ | Blending parameter |
| Kₗ | Length parameter |
| k | Fluid consistency index |
| L | Total length |
| Lₜₐₚₑᵣ | Total length of tapered nozzle |
| l | Steady-state length |
| lₕ | Helix length |
| n | Flow behavior index |
| P | Pressure |
| P_{c} | Cross-sectional perimeter |
| Pᵣ | Input pressure vector |
| Pₚᵢₚₑ | Pipe pressure |
| Pₛₘ | Static mixer pressure |
| Pₜₐₚₑᵣ | Tapered pipe pressure |
| p | Point |
| pₕ | Helix pitch |
| Q | Volumetric flowrate |
| Q_{c} | Control flowrate vector |
| Qₑ | Flowrate error vector |
| Qₘ | Machine learning model flowrate vector |
| Qᵣ | Reference flowrate vector |
| Qₒ | Output flowrate vector |
| S | Tool path segment |
| S_{c} | Cartesian segment |
| Sₑ | Extrusion path segment |
| \dot{S}_{c} | Cartesian segment velocity |
| \dot{S}ₑ | Extrusion segment velocity |
| T | Total time to traverse a tool path segment |
| t | Time |
| t_{f} | Feedforward time |
| tᵣ | Helix thickness |
| tᵣ | Step response time |
| u | Fluid velocity |
| R | iLQR control factor matrix |
| v | Cartesian velocity target |
| v_{c} | Cartesian velocity target |
| vₑ | Extrusion velocity target |
| w | DIW line width |
| X | X axis |
| x | Location on a central axis in fluid model |
| Y | Y axis |
| Z | Z axis |
| Δt | Timestep |
| Δx | Length step |
| α | Taper angle |
| β | Release angle |
| γ | Attack angle |
| ρ | Density |
| Λ | Cartesian objective value |
| Λₑ | Extrusion objective value |
| λ | FECC segmentation length |
| μ | Viscosity |
| μ_{eff} | Effective viscosity |
| ν | Poisson ratio |
| Υ | Tool path |
| Υ_{new} | New tool path |
| φ | Pipe parameter |

1. A method of forming on a substrate a three-dimensional (3D) pattern or article with an apparatus having a nozzle, said method comprising:
(I) selecting a first composition to be printed with the nozzle of the apparatus;
(II) identifying desired characteristics of a pattern or layer to be formed by printing the first composition, wherein at least one of the substrate or the nozzle is moved relative to the other when printing the first composition to form the pattern or layer;
(Ill) determining dimensional differences between the desired characteristics of the pattern or layer and predicted characteristics of the pattern or layer based on computational simulation modeling, or determining dimensional differences between the desired characteristics of the pattern or layer and actual characteristics of a trial layer or trial pattern, based on a flow rate of the first composition, a speed of the substrate and/or the nozzle, and the desired characteristics of the pattern or layer;
(IV) printing the first composition with the nozzle on the substrate to form the pattern or layer;
(V) during (IV) printing, implementing a correction signal to adjust a flow rate of the first composition to minimize the dimensional differences between the desired characteristics of the pattern or layer and the actual or predicted characteristics of the pattern or layer;
optionally, repeating (I)-(V) with independently selected composition(s) to form any additional pattern(s) and/or layer(s); and
(VI) exposing the pattern(s) and/or layer(s) to a solidification condition;
wherein (Ill) determining dimensional differences is not solely carried out in real time during the (IV) printing the first composition to form the pattern or layer.

2. The method of claim 1, wherein the speed of the substrate and/or the nozzle is dynamic due to the desired characteristics of the pattern or layer to be formed, and wherein the dimensional differences between the desired characteristics of the pattern or layer and the actual or predicted characteristics of the pattern or layer are caused by changing the speed of the substrate and/or the nozzle during (IV) printing.

3. The method of claim 2, wherein the flow rate of the first composition is reduced during deceleration of the substrate and/or the nozzle during (IV) printing, and wherein the flow rate of the first composition is increased during acceleration of the substrate and/or the nozzle during (IV) printing, by an amount determined by the determined dimensional differences between the desired characteristics of the pattern or layer and the actual or predicted characteristics of the pattern or layer.

4. The method of claim 2, wherein (Ill) determining dimensional differences between the desired characteristics of the pattern or layer and the actual or predicted characteristics of the pattern or layer is based on predicted characteristics of the pattern or layer from computational simulation.

5. The method of claim 4, wherein computation simulation comprises the characteristic method with boundary conditions.

6. The method of claim 1, wherein (Ill) determining dimensional differences between the desired characteristics of the pattern or layer and the actual or predicted characteristics of the pattern or layer is carried out by first printing a trial pattern or trial layer of the first composition.

7. The method of claim 6, wherein (Ill) determining dimensional differences between the desired characteristics of the pattern or layer and the actual or predicted characteristics of the pattern or layer comprises microscopic imaging of actual characteristics of the trial pattern or trial layer as compared to the desired characteristics of the pattern or layer.

8. The method of claim 1, wherein (Ill) determining dimensional differences between the desired characteristics of the pattern or layer and the actual or predicted characteristics of the pattern or layer comprises computational simulation enhanced in predictive speed and/or accuracy by machine learning from actual printing data obtained in real time or in a previous printing trial.

9. The method of claim 1, wherein the correction signal is generated by computational simulation or computational simulation/machine learning iterations.

10. The method of claim 1, wherein the pattern or layer comprises a filament, and wherein the filament has a substantially constant diameter.

11. The method of claim 1, wherein the pattern or layer comprises a filament, and wherein the filament has a diameter that having a maximum deviation of at least 25% less than that associated with an identical pattern or layer formed without steps (Ill) and (V).

12. The method of claim 1, wherein the apparatus comprises a static mixer for mixing the first composition prior to printing from the nozzle.

13. The method of claim 1, wherein the first composition: (i) comprises a silicone composition; (ii) comprises a thermoset; (iii) is a paste; (iv) has a viscosity of from 500 to 10,000,000 centipoise at 25° C.; or (v) any combination of (i) to (iv).

14. The method of claim 1, wherein the solidification condition is selected from: (i) exposure to moisture; (ii) exposure to heat; (iii) exposure to irradiation; (iv) reduced ambient temperature; (v) exposure to solvent; (vi) exposure to mechanical vibration; (vii) exposure to oxygen; (viii) a time lapse, or (ix) a combination of (i) to (viii).

15. The method of claim 1, wherein the apparatus comprises a positive displacement pump.

16. The method of claim 1, further comprising repeating (I)-(V) with a second composition to form at least one additional pattern or layer.

17. A three-dimensional (3D) pattern or article formed in accordance with the method according to claim 1.
